(19) United States
(12) Patent Application Publication
(10) Pub. No.: US 2017/0116664 A1
(43) Pub. Date: Apr. 27, 2017

(54) METHOD AND APPARATUS FOR CONSTRUCTING INFORMATION ABOUT LOCATION OF DISPLAYED COMMODITY

(71) Applicant: SK PLANET CO., LTD., Seongnam-si (KR)

(72) Inventors: Ho Seok LEE, Seoul (KR); Jong Won WOO, Incheon (KR)

(21) Appl. No.: 15/293,289

(22) Filed: Oct. 14, 2016

(30) Foreign Application Priority Data
Oct. 27, 2015 (KR) 10-2015-0149618
Oct. 29, 2015 (KR) 10-2015-0151413

(51) Int. Cl. G06Q 30/06; G06F 1/16; G06F 3/0346; G06F 3/14

(52) U.S. Cl. CPC G06Q 30/0639; G06F 3/14; G06F 1/163; G06F 3/0346

(57) ABSTRACT

Disclosed herein are a method and apparatus capable of constructing information about the location of a displayed commodity by recognizing a commodity display action and movement action of a user. A method for constructing information about a location of a displayed commodity may include recognizing, by a sensor unit, a commodity display action of a user who has worn an apparatus for constructing location information and storing the commodity display action in a memory unit as first information, recognizing, by the sensor unit, a movement action of the user and storing the movement action in the memory unit as second information, and deriving, by a control unit, commodity information and location information about a displayed commodity based on the first information and second information stored in the memory unit.

### CROSS REFERENCE TO RELATED APPLICATION

The present application claims the benefit of

Korean Patent Application No. 10-2015-0151413 filed in the Korean Intellectual Property Office on Oct. 29, 2015 and Korean Patent Application No. 10-2015-0149618 filed in the Korean Intellectual Property Office on Oct. 27, 2015, the entire contents of which are incorporated herein by reference.

### BACKGROUND OF THE INVENTION

1. Technical Field

The present invention relates to a method and apparatus for constructing information about the location of a displayed commodity and, more particularly, to a method and apparatus capable of constructing information about the location of a displayed commodity by recognizing a commodity display action and movement action of a user.

2. Description of the Related Art

A wearable device literally refers to a device which may be worn on the human body, and includes various types of devices, such as glasses, a watch, a bracelet, shoes, a ring, a belt, a band, a necklace, a headset, and clothing, depending on a part on which the device is worn. Today, such a wearable device is coming into wide use. From among the wearable devices, the wearable glasses, the wearable watch, and the wearable band which are very closely related to the human life and can be easily worn form the most product group.

The wearable device is also called a smart device. The reason for this is that the wearable device needs to be initially driven by user input, but once the wearable device is driven, it can automatically generate various types of additional information and provide them to a user. For example, if a user who has worn a wearable watch wants to measure his or her own heart rate, the wearable watch can measure the heart rate of the user as soon as the user presses a heart rate measurement input button, can generate various types of information based on the measured heart rate, and can provide them to the user. Recently, many wearable devices that do not need to be initially driven by user input are appearing. For example, a wearable band can continue to measure the heart rate of a user although it is not initially driven by user input. In the future, there is a very good possibility that a wearable device will be developed in such a way not to be initially driven by user input. The reason for this is that convenience in device driving is improved if user input is not required.

The origin of various types of additional information provided from such a wearable device to a user includes pieces of information measured from the user.

Accordingly, sensors for measuring various types of information from a user need to be mounted on a wearable device. The more the type of sensor is increased, the more information is measured from a user. Accordingly, a heart rate measurement sensor, a Global Positioning System (GPS) sensor and/or a number-of-steps measurement sensor tend to be essentially mounted on a recent wearable device. Research continues to be carried out to dispose various sensors in a limited space within a wearable device.

A wearable device can measure information from a user through sensors mounted thereon, can generate various types of additional information based on the measured information, and can provide them to the user. For example, the current location of a user may be measured, and information about a nearby store or commodities related to a matter of concern of the user may be provided to the user. Such additional information may be provided through a function embedded in a wearable device itself, but it is impossible for a single wearable device to provide all pieces of additional information to different users. Accordingly, recently, an application installed on a wearable device is also developed. In this case, the application may be considered to be a kind of application program, and may function to generate various types of additional information based on information measured through a function embedded in a wearable device itself and to provide them. In the above example, the provision of information about a nearby store or commodities related to a matter of concern of a user can be provided by an application. That is, whenever a new application is developed, additional information which may be provided to a user through a wearable device is inevitably diversified. The development of an application may be considered to be a companion that steps forward along with the development of a wearable device itself.

A user may feel inconvenient in controlling a wearable device unlike in a portable device, such as a common smart phone, because the wearable device needs to be worn on the body of the user. For example, smart glasses need to be worn on a face. A corresponding user is unable to check an input button with an eye, and inevitably presses the button through a previous memory, feeling or estimation. Accordingly, attempts to control a wearable device itself by recognizing a user's movement, an action, or a gesture through a motion recognition sensor mounted on the wearable device are recently made. To this end, research on such a service continues to be carried out.

### PRIOR ART DOCUMENT

### Patent Document

(Patent Document 1) Korean Patent Application Publication No. 10-2015-0062182 (Jun. 8, 2015)

### SUMMARY OF THE INVENTION

In an embodiment of the present invention, a user can conveniently use a parking facility without inconvenience experienced when he or she exits from the parking facility because a parking fee is automatically deduced using payment information (e.g., SMS, an electronic receipt) generated when he or she performs consumption activities in a method for paying a charge for using the parking facility for consumption activities at a department store, for example.

Furthermore, an embodiment of the present invention is directed to the provision of a service for automatically calculating a parking fee by modifying the existing system of a card company or through a system for calculating a parking fee without affiliation with a card company.

Furthermore, an embodiment of the present invention is directed to the provision of a service by which a user can present digital content capable of a discount and/or a reduction of a fee when a parking fee is calculated in addition to consumption activities within a store.

Furthermore, an embodiment of the present invention is directed to the proposal of a new and advanced method and apparatus, which are capable of constructing information about the location of a displayed commodity by recognizing a user's action to display a commodity and to move through a motion recognition sensor mounted on a wearable device and also mapping derived commodity information and location information to a store map.

Furthermore, an embodiment of the present invention is directed to the provision of a method and apparatus for constructing information about the location of a displayed commodity within a store through a wearable device.

Furthermore, an embodiment of the present invention is directed to the provision of a method and apparatus for constructing information about the location of a displayed commodity and also mapping derived commodity information and location information to a store map.

Technical objects of the present invention are not limited to the aforementioned objects, and those skilled in the art will clearly understand other technical objects not described above from the following description.

In accordance with an aspect of the present invention, a system for automatically calculating a parking fee includes a user terminal configured to receive vehicle information about a vehicle of a user, store the received vehicle information, transfer the vehicle information or location information about the location of the vehicle to a payment history information collection server, collect payment information in response to a request from the payment history information collection server, and provide the payment information to the payment history information collection server, a parking fee calculation server configured to recognize a vehicle number or vehicle information about a vehicle that enters or exits from a parking lot, request payment history information about the user of the vehicle using the recognized vehicle information, receive the requested payment history information from the payment history information collection server, calculate the parking fee of the vehicle, and transfer information about the calculated parking fee to the payment history information collection server, and the payment history information collection server configured to receive the payment information or vehicle information from the user terminal, receive the vehicle information and parking fee of the user from the parking fee calculation server, generate payment history information using the payment information of the user received from the user terminal, approve the provision of the generated payment history information if the vehicle information received from the user terminal is identical with the vehicle information received from the parking fee calculation server as a result of a comparison when the parking fee calculation server requests the provision of the payment history information, transfer the generated payment history information to the parking fee calculation server, and process payment for the parking fee.

The system may further include a content providing server configured to transfer digital content according to the payment history information of the user received from the payment history information collection server to the parking fee calculation server and to transfer authentication information for checking whether the user is a member of an affiliated company or parking fee calculation service providing company related to the digital content to a membership interlocking apparatus.

The system may further include a membership interlocking apparatus configured to perform authentication on the user based on the authentication information received from the content providing server, transfer information about the subscription of the user to the content providing server if, as a result of the execution of the authentication, the user is found to be a membership subscriber, send a membership subscription request message to the user terminal if, as a result of the execution of the authentication, the user is found to be not a membership subscriber, and receive a subscription approval message for the subscription request message transmitted by the user terminal to the user terminal.

A user terminal according to an embodiment of the present invention includes an information input unit configured to receive vehicle information about the vehicle of a user, a data storage unit configured to store the vehicle information received from the information input unit, a data transmission unit configured to transfer the vehicle information stored in the data storage unit to a payment history information collection server, a data reception unit configured to receive a payment information collection request signal from the payment history information collection server, and a payment history information providing unit configured to collect the payment information in response to a request from the payment history information collection server and to provide the collected payment information to the payment history information collection server.

The user terminal may further include a vehicle location confirmation unit configured to confirm a place where the vehicle of the user is located. In this case, the vehicle location confirmation unit may confirm the location of the vehicle by recognizing a beacon installed on the entrance of the parking lot or a fare adjustment office. Furthermore, the data storage unit may further store information about the location of the vehicle, which has been confirmed by the vehicle location confirmation unit.

The payment history information providing unit may start collecting the payment history in response to a request from the payment history information collection server only when the vehicle location confirmation unit confirms that the vehicle of the user enters a parking lot, and may provide payment history information generated during consumption activities performed by the user within a store related to the parking lot only when it is confirmed that the vehicle of the user is located at a place where the parking fee is calculated.

In this case, the payment information may include at least one of SMS payment information and electronic receipt payment information generated using an app card function provided by an application of the user terminal.

The information input unit may further receive digital content information related to the calculation of the parking fee from the user.

A parking fee calculation server according to an embodiment of the present invention includes a vehicle information recognition unit configured to recognize vehicle information about a vehicle that enters or exits from a parking lot, a vehicle information management unit configured to store and manage the vehicle information recognized by the vehicle information recognition unit, a vehicle information transmission unit configured to transfer the vehicle information stored in the vehicle information management unit to a payment history information collection server, a payment history information request unit configured to request the payment history information about a user from the payment history information collection server using the vehicle information stored in the vehicle information management unit, and a payment history information reception unit configured to transfer the payment history information requested by the payment history information request unit to the payment history information collection server.

In this case, the parking fee calculation server may further include a parking fee calculation module configured to calculate the parking fee using the vehicle information recognized by the vehicle information recognition unit and the payment history information of the user received from the payment history information reception unit, a parking fee information transmission unit configured to transfer information about the parking fee calculated by the parking fee calculation module to the payment history information collection server, and a calculation completion confirmation unit configured to receive a result of the payment of the parking fee information transferred by the parking fee information transmission unit from the payment history information collection server and to confirm whether the calculation of the parking fee has been completed.

In this case, if it is confirmed that the calculation of the parking fee has been completed by the calculation completion confirmation unit, the parking fee information transmission unit may further transfer calculation completion information to the payment history information collection server.

The vehicle information recognized by the vehicle information recognition unit may be a vehicle number or an image of the vehicle that enters or exits from the parking lot.

The parking fee calculation server may further include an additional information generation unit configured to generate additional information when the vehicle information recognition unit recognizes the vehicle information. The additional information generated by the additional information generation unit may include information about the time when the vehicle enters the parking lot and information about the time when the vehicle exits from the parking lot.

The parking fee calculation module may include a parking fee calculation unit configured to calculate the parking fee of a vehicle which exits from the parking lot, a parking fee deduction processing unit configured to extract a deducible parking fee from the payment history information of the user in accordance with a predetermined criterion and to deduce the deducible parking fee from the parking fee calculated by the parking fee calculation unit, and a parking fee information providing unit configured to provide calculation completion information if a parking fee left is not present in the parking fee deduction processing unit and to provide information about a parking fee left if the parking fee left is present.

In this case, the parking fee calculation unit may calculate a parking fee using information about the time when a vehicle enters a parking lot and information about the time when the vehicle exits from the parking lot.

In this case, the parking fee information providing unit may receive information about a result of the payment for information about the parking fee left from the payment history information collection server, and may further provide parking fee calculation completion information.

The parking fee calculation module may calculate the parking fee by incorporating digital content provided by the content providing server or the user terminal into the parking fee.

A payment history information collection server according to an embodiment of the present invention includes a first information reception unit configured to receive vehicle information or payment information inputted by a user from a user terminal, a second information reception unit configured to receive vehicle information about the vehicle of the user or parking fee information about the vehicle from a parking fee calculation server, a payment information collection request unit configured to request the user terminal to collect the payment information about the user, a payment history information generation unit configured to generate payment history information using the payment information received from the first information reception unit, a payment history information providing approval unit configured to approve the provision of the payment history information generated by the payment history information generation unit when a parking fee calculation server requests the payment history information, and a payment history information transmission unit configured to transfer the payment history information generated by the payment history information generation unit to the parking fee calculation server when the payment history information providing approval unit approves the provision of the payment history information.

A payment history information collection server according to an embodiment of the present invention may further include a parking fee payment execution unit configured to request the user terminal to pay a parking fee based on the parking fee information received from the parking fee calculation server, receive an approval response to the request, and perform payment for the parking fee and a payment result transmission unit configured to transfer a result of the payment of the parking fee, performed by the parking fee payment execution unit, to the parking fee calculation server.

The payment history information generation unit may generate total payment history information using the payment information that has been received by the first information reception unit from the user terminal and that has been notified in the form of at least one SNS or electronic receipt payment information generated using an app card function provided by an application of at least one user terminal.

In this case, the payment information collection request unit may compare the vehicle information received from the second information reception unit with vehicle information about a vehicle that has entered a parking lot, which has been received from the first information reception unit, and may request the user terminal to collect the payment information if, as a result of the comparison, the vehicle information is found to be identical with the vehicle information about the vehicle that has entered the parking lot.

In this case, the payment history information providing approval unit may compare the vehicle information, received by the first information reception unit from the user terminal, with vehicle information about a vehicle that exits from a parking lot, which has been received by the second information reception unit from the parking fee calculation server, and may approve the provision of the payment history information generated by the payment history information generation unit if, as a result of the comparison, the vehicle information is found to be identical with the vehicle information about the vehicle that exits from the parking lot.

A content providing server according to an embodiment of the present invention includes a payment history information reception unit configured to receive payment history information from a payment history information collection server, a digital content providing unit configured to transfer digital content according to the payment history information received by the payment history information reception unit to a digital content transmission unit, and a digital content transmission unit configured to transfer the digital content, received from the digital content providing unit, to the parking fee calculation server.

In this case, the content providing server may further include an authentication information transmission unit configured to transfer authentication information for confirming whether a user is a member of an affiliated company or a parking fee calculation service providing company related to the digital content, transmitted from the digital content providing unit to the parking fee calculation server, to the membership interlocking apparatus.

A membership interlocking apparatus according to an embodiment of the present invention includes a membership subscriber authentication execution unit configured to perform authentication based on authentication information received from a content providing server, a membership subscription information transmission unit configured to transfer subscription information about a membership subscriber to the content providing server if, as a result of the execution of the authentication of the membership subscriber authentication execution unit, a user is found to be the membership subscriber, a subscription request transmission unit configured to send a membership subscription request message to the user terminal of the user if, as a result of the execution of the authentication of the membership subscriber authentication execution unit, the user is found to be not a membership subscriber, and a subscription approval message reception unit configured to receive a subscription approval message for the subscription request message transmitted by the user terminal.

In accordance with an aspect of the present invention, a method for providing, by a system for automatically calculating a parking fee, a parking fee-automatic calculation service includes the steps of (1) recognizing, by a parking fee calculation server, vehicle information through a vehicle information recognition unit (S1), (2) transferring, by a user terminal, vehicle information stored by a user to a payment history information collection server and transferring, by the parking fee calculation server, the vehicle information recognized through the vehicle information recognition unit to the payment history information collection server (S2), (3) requesting, by the payment history information collection server, the user terminal to collect payment information if the vehicle information received from the user terminal at step (2) is identical with the vehicle information received from the parking fee calculation server at step (2) (S3), (4) collecting, by the user terminal, the payment information in response to the payment information collection request at step (3) (S4), (5) transferring, by the user terminal, the payment information collected at step (4) to the payment history information collection server (S5), (6) generating, by the payment history information collection server, payment history information using the payment information received from the user terminal at step (5) (S6), (7) transferring, by the payment history information collection server, the payment history information generated at step (6) to the parking fee calculation server (S7), (8) calculating, by the parking fee calculation server, a parking fee using the payment history information received from the payment history information collection server at step (7) (S8), (9) transferring parking fee information about the parking fee calculated at step (8) (S9), (10) receiving, by the payment history information collection server, the parking fee information at step (9), transferring calculation completion information to the user terminal if a parking fee left is not present in the parking fee information, and requesting the user terminal to pay a parking fee left if the parking fee left is present in the parking fee information (S10), (11) transferring, by the user terminal, payment approval information about the parking fee left in response to the payment request for the parking fee left at step (10) (S11), (12) transferring, by the payment history information collection server, a result of the payment of the parking fee left to the parking fee calculation server when the payment approval information about the parking fee left is received at step (11) (S12), (13) transferring calculation completion information to the payment history information collection server based on the result of the payment received at step (12) (S13), and (14) transferring, by the payment history information collection server, the calculation completion information received at step (13) to the user terminal (S14).

At step (1), the parking fee calculation server recognizes the vehicle information through the vehicle information recognition unit (S1).

At step (2), the user terminal transfers vehicle information, stored by a user, to a payment history information collection server, and the parking fee calculation server transfers the vehicle information recognized through the vehicle information recognition unit to the payment history information collection server (S2).

At step (3), the payment history information collection server requests the user terminal to collect payment information if the vehicle information received from the user terminal at step (2) is identical with the vehicle information received from the parking fee calculation server at step (2) (S3).

At step (4), the user terminal collects the payment information in response to the payment information collection request at step (3) (S4).

At step (5), the user terminal transfers the payment information collected at step (4) to the payment history information collection server (S5).

At step (6), the payment history information collection server generates payment history information using the payment information received from the user terminal at step (5) (S6).

At step (7), the payment history information collection server transfers the payment history information generated at step (6) to the parking fee calculation server (S7).

At step (8), the parking fee calculation server calculates a parking fee using the payment history information received from the payment history information collection server at step (7) (S8).

At step (9), the parking fee calculation server transfers parking fee information about the parking fee calculated at step (8) (S9).

At step (10), the payment history information collection server receives the parking fee information at step (9), transfers calculation completion information to the user terminal if a parking fee left is not present in the parking fee information, and requests the user terminal to pay a parking fee left if the parking fee left is present in the parking fee information (S10).

At step (11), the user terminal transfers payment approval information about the parking fee left in response to the payment request for the parking fee left at step (10) (S11).

At step (12), the payment history information collection server transfers a result of the payment of the parking fee left to the parking fee calculation server when the payment approval information about the parking fee left is received at step (11) (S12).

At step (13), the payment history information collection server transfers calculation completion information to the payment history information collection server based on the result of the payment received at step (12) (S13).

At step (14), the payment history information collection server transfers the calculation completion information received at step (13) to the user terminal (S14).

A method for providing, by a user terminal, a parking fee-automatic calculation service according to an embodiment of the present invention includes (1) an information input step for receiving vehicle information about the vehicle of a user, (2) a vehicle location confirmation step for confirming a place where the vehicle of the user is located, (3) a vehicle data storage step for storing the vehicle information received at step (1) or location information about the location of the vehicle confirmed at step (2), (4) a vehicle data transmission step for transferring the vehicle information or location information of the vehicle stored at step (3) to a payment history information collection server, (5) a payment information collection signal reception step for receiving a payment information collection signal from the payment history information collection server, and (6) a payment history information providing step for collecting payment information in response to the payment information collection signal received at step (5) and providing the collected payment information to the payment history information collection server.

A method for providing, by a parking fee calculation server, a parking fee-automatic calculation service according to an embodiment of the present invention includes (1) a vehicle information recognition step for recognizing vehicle information about a vehicle that enters or exits from a parking lot, (2) a vehicle information management step for storing and managing the vehicle information recognized at step (1), (3) a payment history information request step for requesting payment history information about the user of the vehicle using the vehicle information stored at step (2), (4) a payment history information reception step for receiving the payment history information of the user requested at step (3) from a payment history information collection server, (5) a parking fee calculation step for calculating a parking fee using the vehicle information recognized at step (1) and the payment history information of the user received at step (4), (6) a parking fee information transmission step for transferring information about the parking fee calculated at step (5) to the payment history information collection server, and (7) a calculation completion confirmation step for receiving a result of the payment of the parking fee information received at step (6) from the payment history information collection server and confirming whether the calculation of the parking fee has been completed.

In this case, step (5) may include (a) a parking fee calculation step for calculating the parking fee using information about the time when the vehicle enters a parking lot and information about the time when the vehicle exits from the parking lot, (b) a parking fee deduction processing step for extracting a deducible parking fee from the payment history information of the user in accordance with a predetermined criterion and deducing the deducible parking fee from the parking fee calculated at step (a), and (c) a parking fee information providing step for providing calculation completion information if a parking fee left is not present as a result of the deduction at step (b) and providing information about a parking fee left if the parking fee left is present as a result of the deduction at step (b).

A method for providing, by a payment history information collection server, a parking fee-automatic calculation service according to an embodiment of the present invention includes (1) an information reception step for receiving vehicle information inputted by a user and payment information from a user terminal and receiving vehicle information recognized by a parking fee calculation server through a vehicle information recognition unit and parking fee information, (2) a payment history information generation step for generating payment history information using the payment information of the user received at step (1), (3) a payment history information providing approval step for comparing the vehicle information inputted by the user with the vehicle information recognized through the vehicle information recognition unit at step (1) when the parking fee calculation server requests the payment history information collection server to provide the payment history information and for approving the provision of the payment history information generated at step (2) if, as a result of the comparison, the vehicle information inputted by the user is found to be identical with the vehicle information recognized through the vehicle information recognition unit, (4) a payment history information transmission step for transferring the payment history information generated at step (2) to the parking fee calculation server if the provision of the payment history information is approved at step (3), (5) a payment execution step for performing the payment of a parking fee based on the parking fee information received at step (4), and (6) a payment result transmission step for transferring a result of the payment of the parking fee at step (5) to the parking fee calculation server.

The “system and method for automatically calculating a parking fee” may be implemented in a program form and may be then recorded on a recording medium readable by an electronic device or distributed through a program download management apparatus (or server).

A method for constructing information about the location of a displayed commodity according to a first embodiment of the present invention includes (a) recognizing, by a sensor unit, a commodity display action of a user who has worn an apparatus for constructing location information and storing the commodity display action in a memory unit as first information, (b) recognizing, by the sensor unit, a movement action of the user and storing the movement action in the memory unit as second information, and (c) deriving, by a control unit, commodity information and location information about a displayed commodity based on the first information and second information stored in the memory unit.

Furthermore, the apparatus for constructing location information may be any one of a smart watch, smart glasses, and a smart band.

Furthermore, the first information may include at least an image of the displayed commodity.

Furthermore, the second information may include at least a reference location, a moving distance, and a moving direction.

Furthermore, the step (c) may include the steps of (c-1) deriving, by the control unit, the commodity information about the displayed commodity based on the image of the displayed commodity of the first information stored in the memory unit and (c-2) deriving, by the control unit, the location information about the displayed commodity based on the reference location, the moving distance, and the moving direction of the second information stored in the memory unit.

The first information may further include at least one of display employee information, a display time, and a display height.

The second information may further include at least one of a moving speed, a moving time, and the number of steps.

At step (c-1), the control unit may correct an error rate of commodity information included in the first information based on the display employee information of the first information.

At step (c-2), if the display time included in the first information is a specific time or more, the control unit may derive the location information based on the second information.

At step (c-2), the control unit may correct an error rate of the moving time of the second information based on the display time of the first information.

At step (c-2), the control unit may derive the location information based on the moving speed of the second information.

At step (c-2), the control unit may derive the location information including the display height based on the display height of the first information.

At step (c-2), the control unit may derive the location information based on the number of steps of the second information.

The method for constructing information about the location of a displayed commodity may further include (d) mapping, by the control unit, the derived commodity information and location information to a store map after step (c).

Furthermore, the method for constructing information about the location of a displayed commodity may be implemented into a recording medium on which a program for being executing in a computer has been recorded.

A method for constructing information about the location of a displayed commodity according to a second embodiment of the present invention may be implemented using an apparatus for constructing information about a location of a displayed commodity, including a sensor unit configured to generate first information and second information by recognizing a commodity display action and movement action of a user, a memory unit configured to store the first information and second information generated by the sensor unit, and a control unit configured to derive commodity information and location information about a displayed commodity based on the first information and second information stored in the memory unit.

Furthermore, the first information may include at least an image of the displayed commodity.

Furthermore, the second information may include at least a reference location, a moving distance, and a moving direction.

Furthermore, the apparatus for constructing information about a location of a displayed commodity may further include a display unit configured to visually output the commodity information and location information derived by the control unit.

Furthermore, the control unit may map the derived commodity information and location information to a store map.

The first information may further include at least one of display employee information, a display time, and a display height.

The second information may further include at least one of a moving speed, a moving time, and the number of steps.

Furthermore, the control unit may derive the location information based on the second information if the display time of the first information stored in the memory unit is a specific time or more.

Furthermore, the control unit may correct an error rate of a commodity image stored in the first information based on the display employee information of the first information stored in the memory unit, may include the corrected error rate in the first information, and may store the first information in the memory unit again.

Furthermore, the control unit may correct an error rate of the moving time of the second information based on the display time of the first information stored in the memory unit, may include the corrected error rate in the second information, and may store the second information in the memory unit again.

Furthermore, the control unit may derive the moving distance of the second information based on the moving speed of the second information stored in the memory unit, may include the derived moving distance in the second information, and may store the second information in the memory unit again.

Furthermore, the apparatus for constructing information about the location of a displayed commodity may be any one of a smart watch, smart glasses, and a smart band.

### BRIEF DESCRIPTION OF THE DRAWINGS

FIG. 1 is a diagram showing the state in which a parking fee calculation system according to an embodiment of the present invention provides a service.

FIG. 2 is a block diagram showing the configuration of a user terminal according to an embodiment of the present invention.

FIG. 3 is a block diagram showing the configuration of a parking fee calculation server according to an embodiment of the present invention.

FIG. 4 is a block diagram showing the configuration of a parking fee calculation module according to an embodiment of the present invention.

FIG. 5 is a block diagram showing the configuration of a payment history information collection server according to an embodiment of the present invention.

FIG. 6 is a block diagram showing the configuration of a content providing server according to an embodiment of the present invention.

FIG. 7 is a block diagram showing the configuration of a membership interlocking apparatus according to an embodiment of the present invention.

FIG. 8 is a diagram showing a method for providing, by a system for automatically calculating a parking fee, a service according to an embodiment of the present invention.

FIG. 9 is a diagram illustrating major elements of an apparatus for constructing information about the location of a displayed commodity.

FIG. 10 is a flowchart illustrating a method for constructing information about the location of a displayed commodity according to an embodiment of the present invention.

FIG. 11 is a diagram showing the state in which a user who has worn the apparatus for constructing information about the location of a displayed commodity takes an action.

FIG. 12 is a diagram illustrating first information and second information stored when a user's action is recognized in the state in which the user has worn the apparatus for constructing information about the location of a displayed commodity.

FIG. 13 is a diagram illustrating a plurality of motion recognition sensors mounted on the apparatus for constructing information about the location of a displayed commodity.

FIG. 14 is a diagram showing the state in which commodity information and location information are displayed on the display unit of the apparatus for constructing information about the location of a displayed commodity.

FIG. 15 is a diagram showing the state in which a user's action is visually recognized through a smart watch.

FIG. 16 is a diagram showing the state in which a method for constructing information about the location of a displayed commodity is provided when a user wears both a smart watch and smart glasses.

### DETAILED DESCRIPTION

Hereinafter, a “system for automatically calculating a parking fee and methods for providing a service using the same” are described in detail with reference to the accompanying drawings. Embodiments to be described are provided in order for those skilled in the art to easily understand the technical spirit of the present invention, and the present invention is not restricted by the embodiments. Furthermore, contents represented in the accompanying drawings have been diagrammed in order to easily describe the embodiments of the present invention, and the contents may be different from drawing forms that are actually implemented.

Elements to be described herein are only examples for implementing the embodiments of the present invention. Accordingly, in other implementations of the present invention, different elements may be used without departing from the spirit and scope of the present invention.

Furthermore, each of the elements may be purely implemented using a hardware or software element, but may be implemented using a combination of various hardware and software elements that perform the same function. Furthermore, two or more elements may be implemented together by a piece of hardware or software.

Furthermore, an expression that some elements are “included” is an expression of an “open type”, and the expression simply denotes that the corresponding elements are present, but should not be construed as excluding additional elements.

Hereinafter, embodiments of the present invention are described in detail with reference to the accompanying drawings.

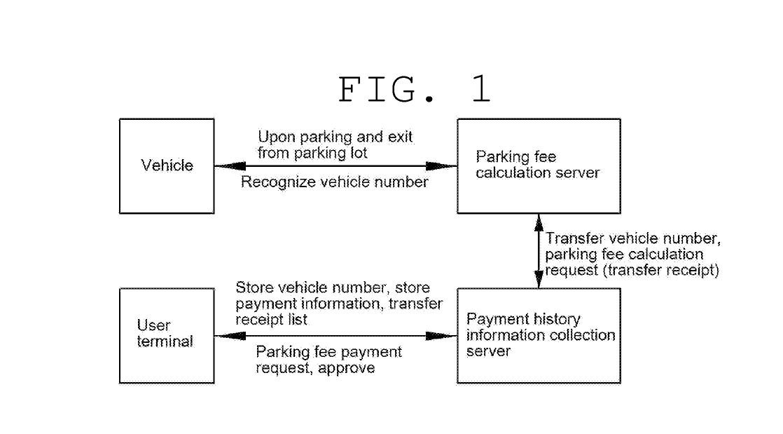

FIG. 1 is a diagram showing the state in which a parking fee calculation system according to an embodiment of the present invention provides a service. The parking fee calculation system according to an embodiment of the present invention includes a user terminal 100, a parking fee calculation server 200, and a payment history information collection server 300. More specifically, the parking fee calculation system includes the user terminal 100 configured to receive vehicle information about the vehicle of a user, store the received vehicle information, transfer the vehicle information or location information about the location of the vehicle to the payment history information collection server 300, collect payment information in response to a request from the payment history information collection server 300, and provide the payment information to the payment history information collection server 300, the parking fee calculation server 200 configured to recognize a vehicle number or vehicle information about the vehicle that enters or exits from a parking lot, request payment history information about the user of the vehicle using the recognized vehicle information, receive the requested payment history information from the payment history information collection server 300, calculate the parking fee of the vehicle, and transfer information about the calculated parking fee to the payment history information collection server 300, and the payment history information collection server 300 configured to receive the payment information or vehicle information from the user terminal 100, receive the vehicle information and parking fee of the user from the parking fee calculation server 200, generate payment history information using the payment information of the user received from the user terminal 100, approve the provision of the generated payment history information if the vehicle information received from the user terminal 100 is identical with the vehicle information received from the parking fee calculation server 200 as a result of a comparison when the parking fee calculation server 200 requests the provision of the payment history information, transfer the generated payment history information to the parking fee calculation server 200, and process payment for the parking fee.

The parking fee calculation system according to an embodiment of the present invention may further include a content providing server 400 configured to transfer digital content according to the payment history information of the user received from the payment history information collection server to the parking fee calculation server 200 and to transfer authentication information for checking whether the user is a member of an affiliated company or parking fee calculation service providing company related to the digital content to a membership interlocking apparatus 500. The parking fee calculation system according to an embodiment of the present invention may further include a membership interlocking apparatus 500 configured to perform authentication on the user based on the authentication information received from the content providing server 400, transfer information about the subscription of the user to the content providing server 400 if, as a result of the execution of the authentication, the user is found to be a membership subscriber, send a membership subscription request message to the user terminal 100 if, as a result of the execution of the authentication, the user is found to be not a membership subscriber, and receive a subscription approval message for the subscription request message transmitted by the user terminal 100 to the user terminal 100.

The user terminal 100, the parking fee calculation server 200, and the payment history information collection server 300 are connected over a wired/wireless communication network. The communication network includes a base station controller, a base station transmitter, a relay station, etc. The base station controller functions to relay a signal between the base station transmitter and a switching station. The communication network supports both a synchronous method and an asynchronous method. Accordingly, in the case of the synchronous method, a Base Station Transmission System (BTS) may become a transmission/reception base station transmitter and a Base Station Controller (BSC) may become a transmission/reception base station controller. In the case of the asynchronous method, a Radio Transceiver Subsystem (RTS) may become the transmission and reception base station transmitter, and a Radio Network Controller (RNC) may become the transmission and reception base station controller. The communication network according to an embodiment of the present invention is not limited thereto, and may collectively refer to a GSM network other than a CDMA network and networks which may be used in the access network of a next-generation mobile communication system to be developed in the future.

The communication network may further include an access point. The access point is a small base station, such as a femto or pico base station chiefly installed in a building. The femto or pico base station is classified depending on how many the wearable devices 100 can be accessed in terms of the classification of a small base station. Furthermore, the access point includes a short-range communication module for performing short-range communication, such as Wireless Fidelity (Wi-Fi), along with the wearable device 100. The short-range communication may be performed in accordance with various standards, such as Radio Frequencies (RF) and an Ultra-Wideband Communication (UWB) including Bluetooth communication, Zigbee communication, infrared rays communication (IrDA), a Ultra High Frequency (UHF), and a Very High Frequency (VHF), in addition to Wi-Fi. The access point may extract the location of a data packet, may designate the best communication route for the extracted location, and may transfer the data packet to a next device, for example, the wearable device 100 along the designated communication route. The access point may be shared by several lines in a common network environment.

The access point is basically divided into a fixed type access point and a mobile type access point. The fixed type access point may include a router, a repeater, a relay station, etc. The mobile type access point may include the bridge product of a specific manufacturer, such as KT's Egg. Such a mobile type access point may read a reception-side address from transmission-side information while guaranteeing free mobility, may designate the most appropriate communication route, and may send data.

In an embodiment of the present invention, each of the apparatus and the server includes a transceiver. In this case, the transceiver includes RF transmission means for up-converting a transmitted signal and amplifying the frequency of the signal, RF reception means for performing low-noise amplification on a received signal and down-converting the frequency of the signal, and so on. The transceiver may include at least one of a wireless communication module and a wired communication module. The wireless communication module may include at least one of a wireless network communication module, a Wireless Local Area Network (WLAN) or Wi-Fi or Worldwide Interoperability for Microwave Access (WiMAX) communication module, and a Wireless Personal Area Network (WPAN) communication module.

The wireless communication module is an element for transmitting and receiving data in accordance with a wireless communication method. If each apparatus or server uses wireless communication, it may send or receive data for providing payment information using any one of the wireless network communication module, the WLAN communication module, and the WPAN communication module.

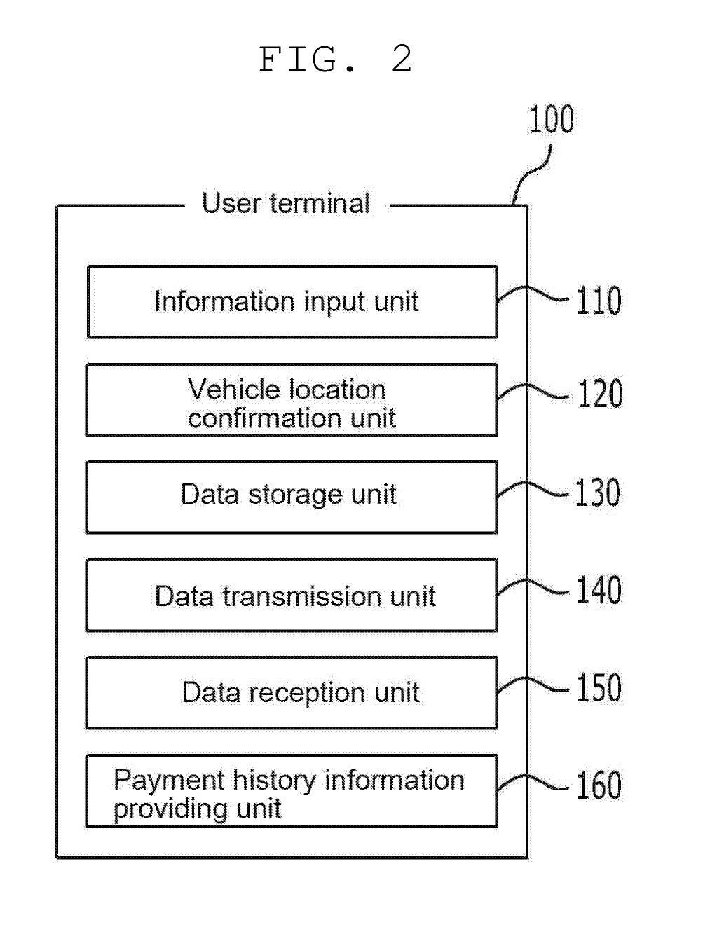

FIG. 2 is a block diagram showing the configuration of a user terminal 100 according to an embodiment of the present invention.

Referring to FIG. 2, the user terminal 100 according to an embodiment of the present invention includes an information input unit 110, a data storage unit 130, a data transmission unit 140, a data reception unit 150, and a payment history information providing unit 160. More specifically, the user terminal 100 includes the information input unit 110 configured to receive vehicle information about the vehicle of a user, the data storage unit 130 configured to store the vehicle information received from the information input unit 110, the data transmission unit 140 configured to transfer the vehicle information, stored in the data storage unit 130, to the payment history information collection server 300, the data reception unit 150 configured to receive a payment information collection request signal from the payment history information collection server 300, and the payment history information providing unit 160 configured to collect payment information in response to a request from the payment history information collection server 300 and provide the collected payment information to the payment history information collection server 300.

The information input unit 110 receives information about the vehicle of a user. Meanwhile, the information input unit 110 may further receive digital content information related to the calculation of a parking fee from the content providing server 400 or a corresponding user. For example, the digital content information may include the coupon number of a parking discount coupon, the movie reservation number or ticket number of a movie ticket and so on. The digital content information may be transmitted from the content providing server 400 to the user terminal 100 based on a payment history, but may be directly inputted by a user.

The data storage unit 130 stores vehicle information received from the information input unit 110. If a vehicle location confirmation unit 120 obtains information about the location of the vehicle, the data storage unit 130 may further store the location information. The data storage unit 130 is a device for storing data, and basically stores data, such as environment variables for search, classification, and analysis. Such a function of the data storage unit 130 may be implemented using a known technology.

The data transmission unit 140 transfers vehicle information, stored in the data storage unit 130, to the payment history information collection server 300.

The data reception unit 150 receives a payment information collection request signal from the payment history information collection server 300.

The payment history information providing unit 160 collects payment information in response to a request from the payment history information collection server 300, and provides the payment information to the payment history information collection server 300.

The user terminal 100 may further include the vehicle location confirmation unit 120 configured to confirm a place where the vehicle of a user is located. In this case, the data storage unit 130 may further store information about the location of the vehicle, which has been confirmed by the vehicle location confirmation unit 120.

In this case, the vehicle location confirmation unit 120 may confirm the location of the vehicle by recognizing a beacon installed on the entrance of a parking lot or a fare adjustment office. More specifically, the vehicle location confirmation unit 120 confirms whether a vehicle enters a parking lot or exits from the parking lot. In this case, the vehicle location confirmation unit 120 may confirm a place where the vehicle is located using mobile GPS information. That is, the vehicle location confirmation unit 120 may confirm that a vehicle enters a parking lot when the vehicle is located at the entrance of the parking lot, and may confirm that the vehicle exits from the parking lot when the vehicle is located at the exit of the parking lot.

In this case, the payment history information providing unit 160 may start collecting a payment history in response to a request from the payment history information collection server 300 only when the vehicle location confirmation unit 120 confirms that the vehicle of a corresponding user enters a parking lot, and may provide payment history information generated during consumption activities performed by the user within a store related to the parking lot only when it is confirmed that the vehicle of the user is located at a place where the parking fee is calculated. That is, there is an advantage in that a payment history can be collected or provided based on a more accurate point of time and a place where a vehicle is located using information about the vehicle and the location of the vehicle.

The vehicle location confirmation unit 120 may confirm the location of a user using a communication device installed in a parking lot other than GPSs. In this case, the communication device may use Wi-Fi or a beacon. Wi-Fi or the beacon is a smart terminal short-range communication technology in which the location of the user terminal 100 within a radius of 50˜70 m is detected, enabling message transmission, mobile payment, etc. Wi-Fi or the beacon has a longer available length than Near Field Communication (NFC), and is suitable for O2O services that connect online and offline. If this technology is used, a guidance service, a mobile coupon, etc. at a specific place can be used.

For example, this technology may be used in various ways, such as that information related to parking can be automatically checked when the vehicle of a customer who uses a parking lot enters or exits from the parking lot and a parking fee discount coupon can also be provided.

Furthermore, this technology consumes low power, requires low battery consumption for a smart phone, can confirm an accurate location within a parking lot compared to GPSs, and can be used to collect personal information because it can accurately confirm the location of a user who uses a smart phone.

The user terminal 100 may further include a display unit (not shown) configured to display calculation completion information received from the payment history information collection server 300.

The display unit may include a Liquid Crystal Display (LCD), a Thin Film Transistor LCD (TFT-LCD), Organic Light Emitting Diodes (OLED), a Light-Emitting Diode (LED), an Active Matrix Organic LED (AMOLED), a flexible display, a 3-dimensional (3D) display, etc. In this case, the display unit may be formed in the form of a touch screen. If the display unit is formed in the form of a touch screen as described above, it may perform some of all of functions of an input unit. In particular, the display unit may display payment information collection request information, information related to the parking fee left, digital content related to a parking fee discount, calculation completion information or the like, which is received from the payment history information collection server 300 according to an embodiment of the present invention.

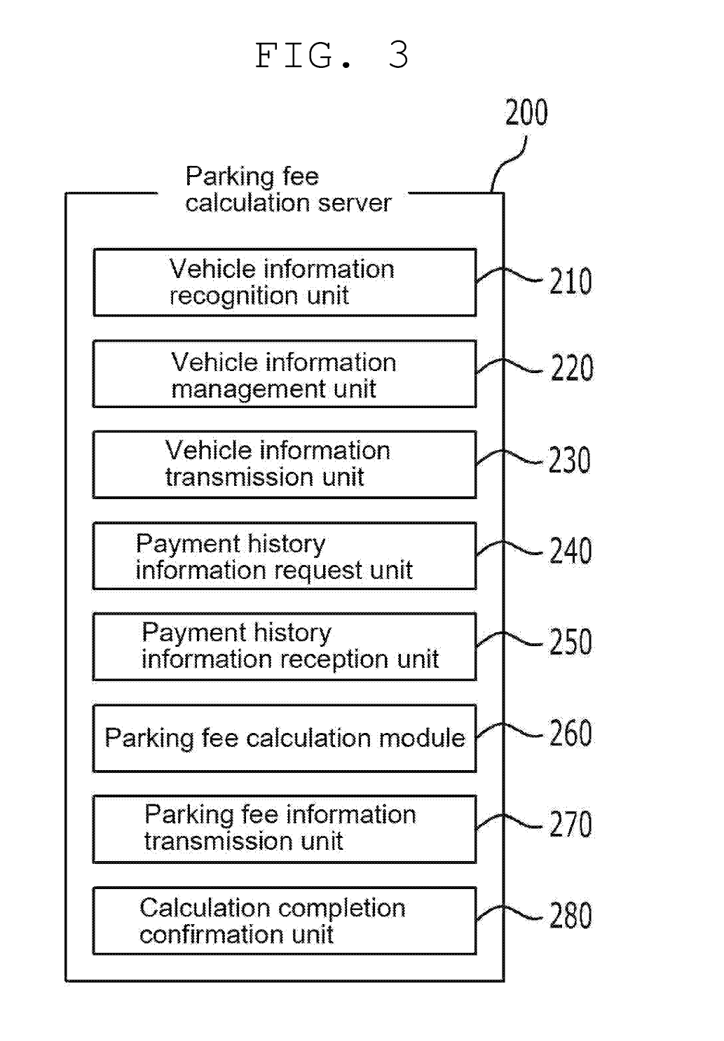

FIG. 3 is a block diagram showing the configuration of the parking fee calculation server 200 according to an embodiment of the present invention.

Referring to FIG. 3, the parking fee calculation server 200 according to an embodiment of the present invention includes a vehicle information recognition unit 210, a vehicle information management unit 220, a vehicle information transmission unit 230, a payment history information request unit 240, a payment history information reception unit 250, a parking fee calculation module 260, a parking fee information transmission unit 270, and a calculation completion confirmation unit 280. More specifically, the parking fee calculation server 200 includes the vehicle information recognition unit 210 configured to recognize vehicle information about a vehicle that enters or exits from a parking lot, the vehicle information management unit 220 configured to store and manage the vehicle information recognized by the vehicle information recognition unit 210, the vehicle information transmission unit 230 configured to transfer the vehicle information stored in the vehicle information management unit 220 to the payment history information collection server 300, the payment history information request unit 240 configured to request payment history information about a user from the payment history information collection server 300 using the vehicle information stored in the vehicle information management unit 220, and the payment history information reception unit 250 configured to transfer the payment history information requested by the payment history information request unit 240 to the payment history information collection server 300.

The parking fee calculation server 200 may further include the parking fee calculation module 260 configured to calculate a parking fee using the vehicle information recognized by the vehicle information recognition unit 210 and the payment history information of the user received from the payment history information reception unit 250, the parking fee information transmission unit 270 configured to transfer information about the parking fee calculated by the parking fee calculation module 260 to the payment history information collection server 300, and the calculation completion confirmation unit 280 configured to receive a result of the payment of the parking fee information transferred by the parking fee information transmission unit 270 from the payment history information collection server 300 and confirm whether the calculation of the parking fee has been completed.

The vehicle information recognition unit 210 recognizes information about a vehicle that enters or exits from a parking lot. In this case, the vehicle information recognized by the vehicle information recognition unit 210 may be a vehicle number or an image of the vehicle that enters or exits from the parking lot.

The vehicle information management unit 220 stores and manages vehicle information recognized by the vehicle information recognition unit 210. The vehicle information management unit 220 may store vehicle information and manage information about the vehicles of different users. For example, in addition to the storage and management of information about the vehicles of different users, the vehicle information management unit 220 may store information about another vehicle of a user if the same user uses another vehicle, and may arrange and manage pieces of vehicle information for each user so that the pieces of vehicle information can be subsequently searched for rapidly.

The vehicle information transmission unit 230 transfers vehicle information, stored in the vehicle information management unit 220, to the payment history information collection server 300.

The payment history information request unit 240 requests information about the payment history of a user from the payment history information collection server 300 using vehicle information stored in the vehicle information management unit 220.

The payment history information reception unit 250 receives information about the payment history of a user, requested by the payment history information request unit 240, from the payment history information collection server 300.

The parking fee calculation module 260 calculates a parking fee using information about the vehicle of a user, recognized by the vehicle information recognition unit 210, and information about the payment history of the user received from the payment history information reception unit 250.

The parking fee information transmission unit 270 transfers information about a parking fee, calculated by the parking fee calculation module 260, to the payment history information collection server 300. In this case, if it is confirmed that the calculation of the parking fee has been completed by the calculation completion confirmation unit 280, the parking fee information transmission unit 270 may further transfer calculation completion information to the payment history information collection server 300.

The calculation completion confirmation unit 280 may receive information about the results of the payment of a parking fee, transferred by the parking fee information transmission unit 270, from the payment history information collection server 300, and may confirm whether the calculation of the parking fee has been completed.

The parking fee calculation server 200 according to an embodiment of the present invention may further include an additional information generation unit configured to generate additional information when the vehicle information recognition unit 210 recognizes vehicle information. The generated additional information may include information about the time when a vehicle enters a parking lot and information about the time when the vehicle exits from the parking lot. The parking fee calculation module 260 may calculate the parking fee of a vehicle that enters and exits from a parking lot using such additional information.

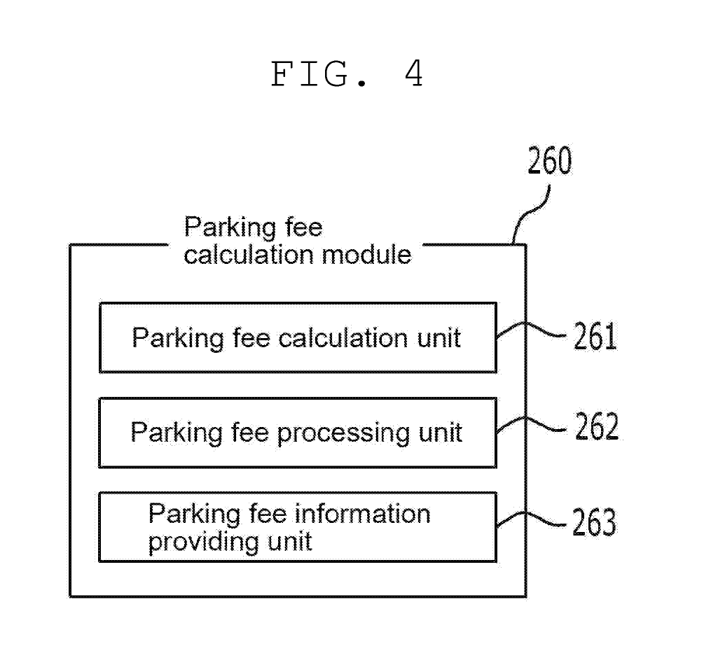

FIG. 4 is a block diagram showing the configuration of the parking fee calculation module 260 according to an embodiment of the present invention.

Referring to FIG. 4, the parking fee calculation module 260 of the parking fee calculation server 200 according to an embodiment of the present invention includes a parking fee calculation unit 261, a parking fee deduction processing unit 262, and a parking fee information providing unit 263. More specifically, the parking fee calculation module 260 includes the parking fee calculation unit 261 configured to calculate a parking fee using information about the time when a vehicle enters a parking lot and information about the time when the vehicle exits from the parking lot, which have been generated by the additional information generation unit, the parking fee deduction processing unit 262 configured to extract a deducible parking fee from the payment history information of the user in accordance with a predetermined criterion and to deduce the deducible parking fee from the parking fee calculated by the parking fee calculation unit 261, and the parking fee information providing unit 263 configured to provide calculation completion information if a parking fee left is not present in the parking fee deduction processing unit 262 and to provide information about a parking fee left if the parking fee left is present.

The parking fee calculation unit 261 may calculate a parking fee using information about the time when a vehicle enters a parking lot and information about the time when the vehicle exits from the parking lot. The parking fee calculation unit 261 may determine the time when a vehicle enters a parking lot to be an entrance time and the time when the vehicle exits from the parking lot to be an exit time.

The parking fee deduction processing unit 262 extracts a deducible parking fee from the payment history information of the user in accordance with a predetermined criterion, and deduces the deducible parking fee from a parking fee calculated by the parking fee calculation unit 261. A service provider may set such a deduction so that a parking fee is deduced if a total payment amount is a predetermined amount or more or if a payment history is present in payment history information. For example, a service provider may set such a deduction in various ways, such as that a total parking fee is deduced depending on a payment amount or that a parking fee left is exempted if an amount of money left after a deduction is a specific amount or less.

The parking fee calculation module 260 may calculate a parking fee by incorporating digital content provided by the content providing server or the user terminal 100 into the parking fee. For example, the parking fee calculation module 260 may set a parking fee so that the parking fee is deduced or fully exempted depending on a parking fee discount coupon number, a movie reservation number, or a ticket number inputted by a user through the user terminal 100.

Furthermore, a parking fee may be calculated in such a manner that the content providing server 400 automatically provides digital content (e.g., a coupon) to the user terminal 100 based on a payment history. For example, the digital content may be a parking fee discount coupon that is basically provided if a user is a member, or may be the movie ticket number or reservation number of a movie ticket according to a movie payment history.

The parking fee information providing unit 263 provides calculation completion information if a parking fee left is not present in the parking fee deduction processing unit 262, and provides information about a parking fee left if a parking fee left is present in the parking fee deduction processing unit 262. In this case, the parking fee information providing unit 263 may receive information about a result of the payment for information about the parking fee left from the payment history information collection server 300, and may further provide parking fee calculation completion information.

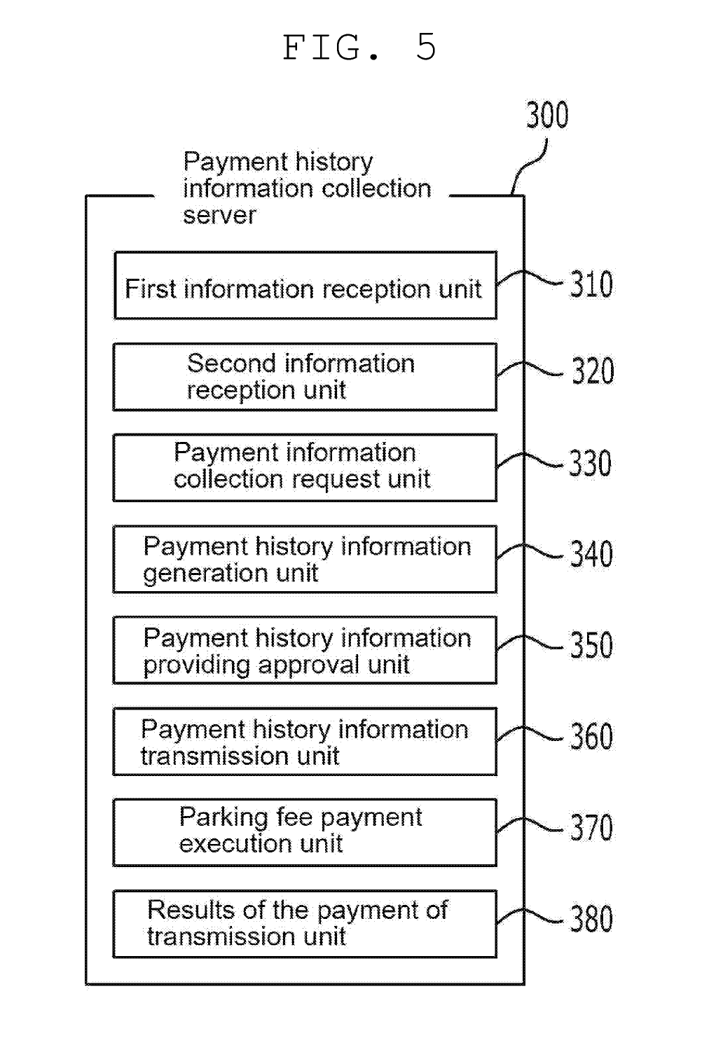

FIG. 5 is a block diagram showing the configuration of the payment history information collection server 300 according to an embodiment of the present invention.

Referring to FIG. 5, the payment history information collection server 300 according to an embodiment of the present invention includes a first information reception unit 310, a second information reception unit 320, a payment information collection request unit 330, a payment history information generation unit 340, a payment history information providing approval unit 350, and a payment history information transmission unit 360.

More specifically, the payment history information collection server 300 includes the second information reception unit 320 configured to receive vehicle information about the vehicle of a user or parking fee information about the vehicle from the parking fee calculation server 200, the payment information collection request unit 330 configured to request the user terminal 100 to collect payment information about the user, the payment history information generation unit 340 configured to generate payment history information using the payment information received from the first information reception unit 310, the payment history information providing approval unit 350 configured to approve the provision of the payment history information generated by the payment history information generation unit 340 if the parking fee calculation server 200 requests the payment history information, and the payment history information transmission unit 360 configured to transfer the payment history information, generated by the payment history information generation unit 340, to the parking fee calculation server 200 if the payment history information providing approval unit 350 approves the provision of the payment history information.

The payment history information collection server 300 may further include a parking fee payment execution unit 370 configured to request the user terminal 100 to pay the parking fee based on the parking fee information received from the parking fee calculation server 200, receive an approval response to the request, and perform payment for the parking fee and a payment result transmission unit 380 configured to transfer a result of the payment of the parking fee, performed by the parking fee payment execution unit 370, to the parking fee calculation server 200.

The first information reception unit 310 receives vehicle information or payment information inputted by a user from the user terminal 100.

The second information reception unit 320 receives the vehicle information or parking fee information from the parking fee calculation server 200.

The payment information collection request unit 330 requests the user terminal 100 to collect the payment information.

In this case, the payment information collection request unit 330 may compare the vehicle information received from the second information reception unit 320 with vehicle information about a vehicle that has entered a parking lot, which has been received from the first information reception unit 310, and may request the user terminal 100 to collect the payment information if, as a result of the comparison, the vehicle information is found to be identical with the vehicle information about the vehicle that has entered the parking lot.

The payment history information generation unit 340 generates payment history information using the payment information of the user received from the first information reception unit 310. The payment history information generation unit 340 may generate total payment history information using the payment information that has been received by the first information reception unit from the user terminal 100 and that has been notified in the form of at least one SNS or electronic receipt payment information generated using an app card function provided by an application of at least one user terminal 100.

The payment history information providing approval unit 350 approves the provision of the payment history information generated by the payment history information generation unit 340 when the parking fee calculation server 200 requests the provision of the payment history information.

In this case, the payment history information providing approval unit 350 may compare the vehicle information, received by the first information reception unit 310 from the user terminal 100, with vehicle information about a vehicle that exits from a parking lot, which has been received by the second information reception unit 320 from the parking fee calculation server 200, and may approve the provision of the payment history information generated by the payment history information generation unit 340 if, as a result of the comparison, the vehicle information is found to be identical with the vehicle information about the vehicle that exits from the parking lot.

When the payment history information providing approval unit 350 approves the provision of the payment history information, the payment history information transmission unit 360 transfers the payment history information, generated by the payment history information generation unit 340, to the parking fee calculation server 200.

The payment history information collection server 300 requests the user terminal 100 to pay the parking fee based on the parking fee information transferred by the parking fee calculation server 200. The parking fee payment execution unit 370 receives an approval response to the request and performs payment for the parking fee.

The payment result transmission unit 380 transfers the results of the payment of the parking fee, performed by the parking fee payment execution unit 370, to the parking fee calculation server 200.

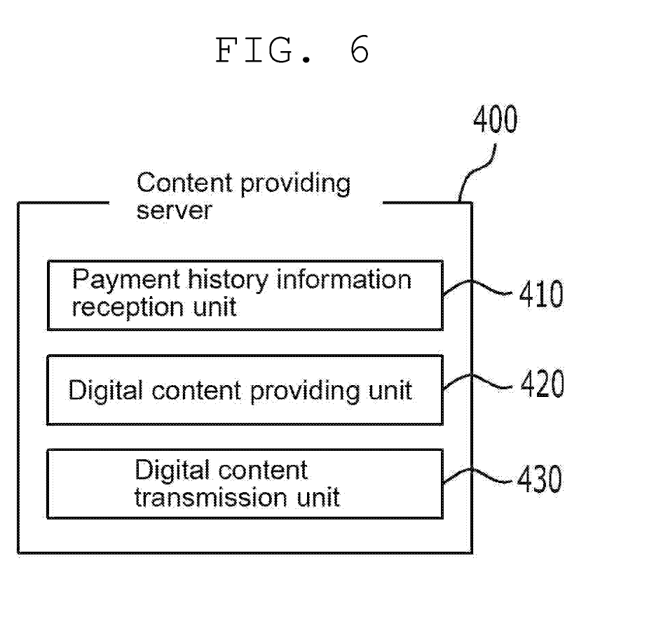

FIG. 6 is a block diagram showing the configuration of the content providing server 400 according to an embodiment of the present invention.

Referring to FIG. 6, the content providing server 400 according to an embodiment of the present invention includes a payment history information reception unit 410, a digital content providing unit 420, and a digital content transmission unit 430.

More specifically, the content providing server 400 includes the payment history information reception unit 410 configured to receive payment history information from the payment history information collection server 300, the digital content providing unit 420 configured to transfer digital content according to the payment history information received by the payment history information reception unit 410 to the digital content transmission unit 430, and the digital content transmission unit 430 configured to transfer the digital content, received from the digital content providing unit 420, to the parking fee calculation server 200.

The content providing server 400 may further include an authentication information transmission unit configured to transfer authentication information for confirming whether a user is a member of an affiliated company or a parking fee calculation service providing company related to the digital content, transmitted from the digital content providing unit 420 to the parking fee calculation server 200, to the membership interlocking apparatus 500.

The payment history information reception unit 410 receives payment history information for providing a user of a parking fee-automatic calculation service with digital content (e.g., a parking fee discount coupon) according to a condition from the payment history information collection server 300. The received payment history information refers to the latest payment history information which has been transmitted by the service user in real time.

The digital content providing unit 420 transfers the digital content according to the payment history information, which has been received from the payment history information reception unit 410, to the digital content transmission unit 430.

The digital content transmission unit 430 transfers the digital content, received from the digital content providing unit 420, to the parking fee calculation server 200.

The content providing server 400 may further include an authentication information transmission unit configured to transfer authentication information for confirming whether a user is a member of an affiliated company or a parking fee calculation service providing company related to the digital content, transmitted from the digital content providing unit 420 to the parking fee calculation server 200, to the membership interlocking apparatus 500. In this case, the vehicle number, telephone number, name or content providing history of the service user and/or other various types of information may be used as the authentication information.

In this case, in the digital content, “digital” refers to an information representation method, and “content” collectively refers to information, knowledge or a database having various forms, such as a symbol, a character, a sound, video, a picture and/or an image. The digital content corresponds to the contents having a form, such as a character, a sound, a picture or an image distributed through the Internet, and does not refer to information and simple contents, but refers to content having transaction and services inherent therein as assets that create added values using several information technologies. For example, the digital content may include an application that is transferred to the user terminal 100 and executed and that is related to a service provided by a service providing company, an electronic coupon related to a store, an electronic coupon related to a membership and so on.

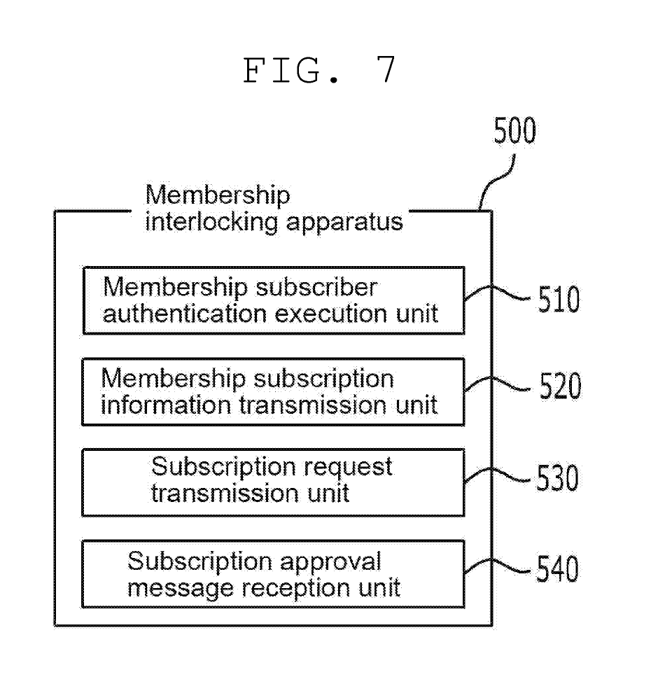

FIG. 7 is a block diagram showing the configuration of a membership interlocking apparatus 500 according to an embodiment of the present invention.

Referring to FIG. 7, the membership interlocking apparatus 500 according to an embodiment of the present invention includes a membership subscriber authentication execution unit 510, a membership subscription information transmission unit 520, a subscription request transmission unit 530, and a subscription approval message reception unit 540.

More specifically, the membership interlocking apparatus 500 includes the membership subscriber authentication execution unit 510 configured to perform authentication based on authentication information received from the content providing server 400, the membership subscription information transmission unit 520 configured to transfer subscription information about a membership subscriber to the content providing server 400 if, as a result of the execution of the authentication of the membership subscriber authentication execution unit, a user is found to be the membership subscriber, the subscription request transmission unit 530 configured to send a membership subscription request message to the user terminal 100 of the user if, as a result of the execution of the authentication of the membership subscriber authentication execution unit, the user is found to be not a membership subscriber, and the subscription approval message reception unit 540 configured to receive a subscription approval message for the subscription request message transmitted by the user terminal 100.

If, as a result of the execution of the authentication of the membership subscriber authentication execution unit, a user is found to be a membership subscriber, the membership subscription information transmission unit 520 transfers subscription information about the membership subscriber to the content providing server 400. When the membership subscription information transmission unit 520 sends the subscription information to the content providing server 400, the content providing server 400 has the right to transfer digital content (e.g., a coupon) to the user of a parking fee-automatic calculation service. In this case, there is an advantage in that a user of a parking fee-automatic calculation service can be induced to become a member of a service of an affiliated company which provides corresponding digital content (e.g., a parking fee discount coupon).

If, as a result of the execution of the authentication of the membership subscriber authentication execution unit, the user is found to be not a membership subscriber, the subscription request transmission unit 530 sends a membership subscription request message to the user terminal 100.

The subscription approval message reception unit 540 receives a subscription approval message for the subscription request message transmitted by the user terminal 100.

In an embodiment of the present invention, the membership interlocking apparatus 500 is an apparatus (or server) for inducing a user to become a member, and may be further included depending on the need of a parking fee-automatic calculation service providing company and/or a platform providing company.

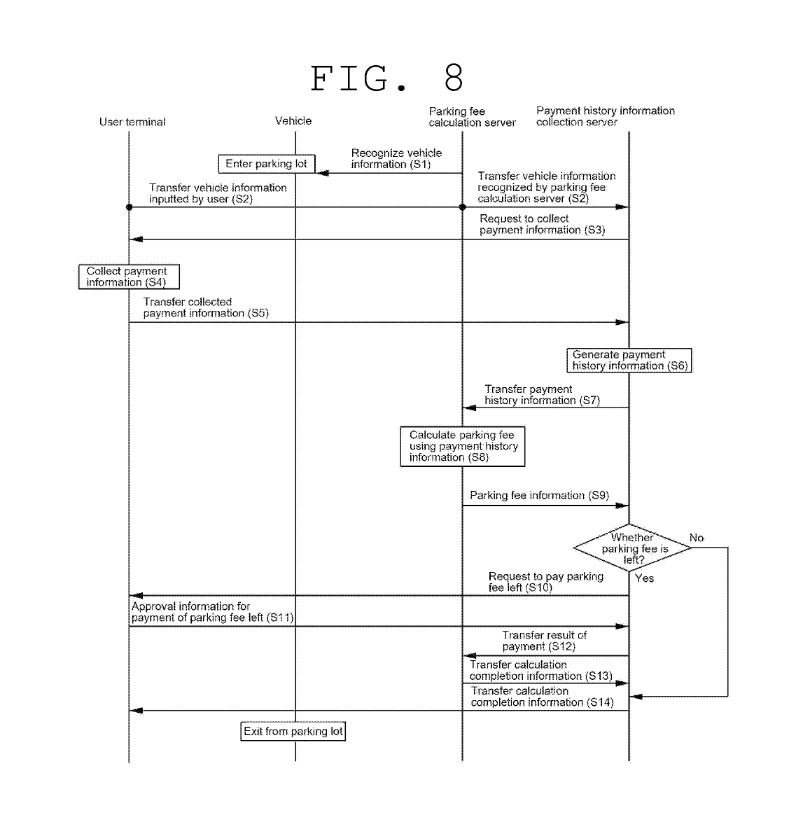

FIG. 8 is a diagram showing a method for providing, by the system for automatically calculating a parking fee, a service according to an embodiment of the present invention.

Referring to FIG. 8, the method for providing, by the system for automatically calculating a parking fee, a parking fee-automatic calculation service according to an embodiment of the present invention includes (1) a vehicle information recognition step, (2) a vehicle information transfer step, (3) a payment information collection request step, (4) a payment information collection step, (5) a payment information transfer step, (6) a payment history information generation step, (7) a payment history information transfer step, (8) a parking fee calculation step, (9) a parking fee information transfer step, (10) a parking fee payment request step, (11) a fee payment approval information transfer step, (12) a payment result transfer step, (13) a calculation completion information transfer step, and (14) a calculation completion information transfer step.

More specifically, the method for providing, by the system for automatically calculating a parking fee, a parking fee-automatic calculation service includes the steps of (1) recognizing, by the parking fee calculation server 200, vehicle information through the vehicle information recognition unit 210 (S1), (2) transferring, by the user terminal 100, vehicle information stored by a user to the payment history information collection server 300 and transferring, by the parking fee calculation server 200, the vehicle information recognized through the vehicle information recognition unit 210 to the payment history information collection server 300 (S2), (3) requesting, by the payment history information collection server 300, the user terminal 100 to collect payment information if the vehicle information received from the user terminal 100 at step (2) is identical with the vehicle information received from the parking fee calculation server 200 at step (2) (S3), (4) collecting, by the user terminal 100, the payment information in response to the payment information collection request at step (3) (S4), (5) transferring, by the user terminal 100, the payment information collected at step (4) to the payment history information collection server 300 (S5), (6) generating, by the payment history information collection server 300, payment history information using the payment information received from the user terminal 100 at step (5) (S6), (7) transferring, by the payment history information collection server 300, the payment history information generated at step (6) to the parking fee calculation server 200 (S7), (8) calculating, by the parking fee calculation server 200, a parking fee using the payment history information received from the payment history information collection server 300 at step (7) (S8), (9) transferring parking fee information about the parking fee calculated at step (8) (S9), (10) receiving, by the payment history information collection server 300, the parking fee information at step (9), transferring calculation completion information to the user terminal 100 if a parking fee left is not present in the parking fee information, and requesting the user terminal 100 to pay a parking fee left if the parking fee left is present in the parking fee information (S10), (11) transferring, by the user terminal 100, payment approval information about the parking fee left in response to the payment request for the parking fee left at step (10) (S11), (12) transferring, by the payment history information collection server 300, a result of the payment of the parking fee left to the parking fee calculation server 200 when the payment approval information about the parking fee left is received at step (11) (S12), (13) transferring calculation completion information to the payment history information collection server 300 based on the result of the payment received at step (12) (S13), and (14) transferring, by the payment history information collection server 300, the calculation completion information received at step (13) to the user terminal 100 (S14).

A method for providing, by the user terminal 100, a parking fee-automatic calculation service according to an embodiment of the present invention includes (1) a vehicle information input step, (2) a vehicle location confirmation step, (3) a vehicle data storage step, (4) a vehicle data transmission step, (5) a payment information collection signal reception step, and (6) a payment history information providing step.

More specifically, the method for providing, by the user terminal 100, a parking fee-automatic calculation service includes (1) the information input step for receiving vehicle information about the vehicle of a user, (2) the vehicle location confirmation step for confirming a place where the vehicle of the user is located, (3) the vehicle data storage step for storing the vehicle information received at step (1) or location information about the location of the vehicle confirmed at step (2), (4) the vehicle data transmission step for transferring the vehicle information and location information of the vehicle stored at step (3) to the payment history information collection server 300, (5) the payment information collection signal reception step for receiving a payment information collection signal from the payment history information collection server 300, and (6) the payment history information providing step for collecting payment information in response to the payment information collection signal received at step (5) and providing the collected payment information to the payment history information collection server 300.

A method for providing, by the parking fee calculation server 200, a parking fee-automatic calculation service according to an embodiment of the present invention includes (1) a vehicle information recognition step, (2) a vehicle information management step, (3) a payment history information request step, (4) a payment history information reception step, (5) a parking fee calculation step, (6) a parking fee information transmission step, and (7) a calculation completion confirmation step.

More specifically, the method for providing, by the parking fee calculation server 200, a parking fee-automatic calculation service includes (1) the vehicle information recognition step for recognizing vehicle information about a vehicle that enters or exits from a parking lot, (2) the vehicle information management step for storing and managing the vehicle information recognized at step (1), (3) the payment history information request step for requesting payment history information about the user of the vehicle using the vehicle information stored at step (2), (4) the payment history information reception step for receiving the payment history information of the user requested at step (3) from the payment history information collection server 300, (5) the parking fee calculation step for calculating a parking fee using the vehicle information recognized at step (1) and the payment history information of the user received at step (4), (6) the parking fee information transmission step for transferring information about the parking fee calculated at step (5) to the payment history information collection server 300, and (7) the calculation completion confirmation step for receiving a result of the payment of the parking fee information received at step (6) from the payment history information collection server 300 and confirming whether the calculation of the parking fee has been completed.

In the method for providing, by the parking fee calculation server 200, a parking fee-automatic calculation service, step (5) may include (a) a parking fee calculation step for calculating the parking fee using information about the time when the vehicle enters a parking lot and information about the time when the vehicle exits from the parking lot, (b) a parking fee deduction processing step for extracting a deducible parking fee from the payment history information of the user in accordance with a predetermined criterion and deducing the deducible parking fee from the parking fee calculated at step (a), and (c) a parking fee information providing step for providing calculation completion information if a parking fee left is not present as a result of the deduction at step (b) and providing information about a parking fee left if the parking fee left is present as a result of the deduction at step (b).

A method for providing, by the payment history information collection server 300, a parking fee-automatic calculation service according to an embodiment of the present invention includes (1) a first information or second information reception step, (2) a payment history information generation step, (3) a payment history information providing approval step, (4) a payment history information transmission step, (5) a payment execution step, and (6) a payment result transmission step.

More specifically, the method for providing, by the payment history information collection server 300, a parking fee-automatic calculation service includes (1) the information reception step for receiving vehicle information inputted by a user and payment information from the user terminal 100 and receiving vehicle information recognized by the parking fee calculation server 200 through the vehicle information recognition unit 210 and parking fee information, (2) the payment history information generation step for generating payment history information using the payment information of the user received at step (1), (3) the payment history information providing approval step for comparing the vehicle information inputted by the user with the vehicle information recognized through the vehicle information recognition unit 210 at step (1) when the parking fee calculation server 200 requests the payment history information collection server 300 to provide the payment history information and for approving the provision of the payment history information generated at step (2) if, as a result of the comparison, the vehicle information inputted by the user is found to be identical with the vehicle information recognized through the vehicle information recognition unit 210, (4) the payment history information transmission step for transferring the payment history information generated at step (2) to the parking fee calculation server 200 if the provision of the payment history information is approved at step (3), (5) the payment execution step for performing the payment of a parking fee based on the parking fee information received at step (4), and (6) the payment result transmission step for transferring a result of the payment of the parking fee at step (5) to the parking fee calculation server 200.

Such a method for providing a service using the system for automatically calculating a parking fee may be written in a program form, and pieces of code and code segments that form the program may be easily reasoned by a programmer skilled in the art. Furthermore, a program regarding the method for providing a service using the system for automatically calculating a parking fee may be stored in information storage media readable by an electronic device and may be read and executed by an electronic device.

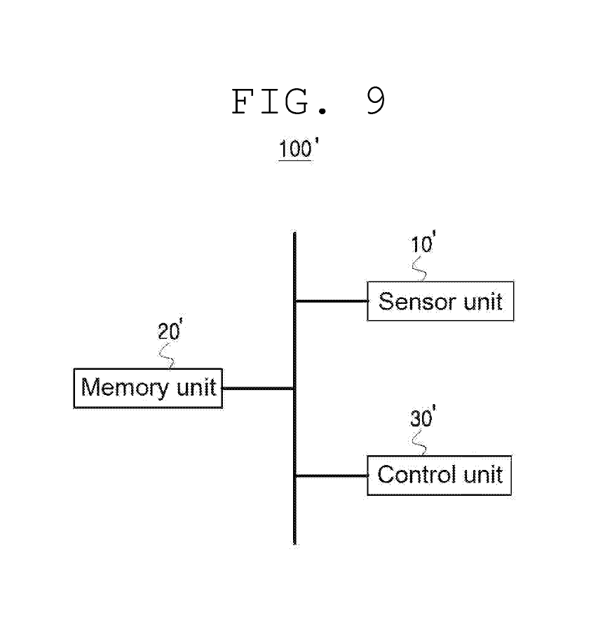

FIG. 9 is a diagram illustrating major elements of an apparatus 100′ for constructing information about the location of a displayed commodity. However, the major elements are only one embodiment, and some of the elements may be omitted or some elements may be added to the apparatus.

A sensor unit 10′ is mounted on the apparatus 100′ for constructing information about the location of a displayed commodity, and measures various types of information from a user. The type of sensor included in the sensor unit 10′ is not limited, and information measured by the sensor unit is not limited. For example, the sensor unit 10′ may include one or more of a motion recognition sensor, a camera sensor, an infrared sensor, a GPS sensor, a gyro sensor, a displacement sensor, a pressure sensor, a torque sensor, a proximity sensor, a gravity sensor, an image sensor, and other known sensors. However, the type of information capable of being sensed by each of the sensors has been determined. Accordingly, the sensor unit 10′ of the apparatus 100′ for constructing information about the location of a displayed commodity, which recognizes a commodity display action and movement action of a user, may include one or more of a camera sensor, a motion recognition sensor, a displacement sensor, and a proximity sensor capable of recognizing the actions.

A memory unit 20′ stores various types of information which have been measured from a user and generated by the sensor unit 10′. The memory unit 20′ may include known storage media, and may include one or more of known storage media, such as ROM, PROM, EPROM, EEPROM, and RAM. In the apparatus 100′ for constructing information about the location of a displayed commodity, the memory unit 20′ may need to continue to store new information measured by the sensor unit 10′. In this case, a storage medium capable of the input and deletion of information may be used as the memory unit 20′ because existing information may need to be deleted depending on the capacity of the memory unit 20′.

A control unit 30′ derives additional information based on information stored in the memory unit 20′. More specifically, the control unit 30′ derives commodity information and location information about a displayed commodity by analyzing information stored in the memory unit 20′. Accordingly, the control unit 30′ may access the memory unit 20′ freely. The control unit 30′ also functions to map derived commodity information and location information to a store map simultaneously with the derivation of the commodity information and location information and to display the store map on a display unit 40′. This is described in detail later.

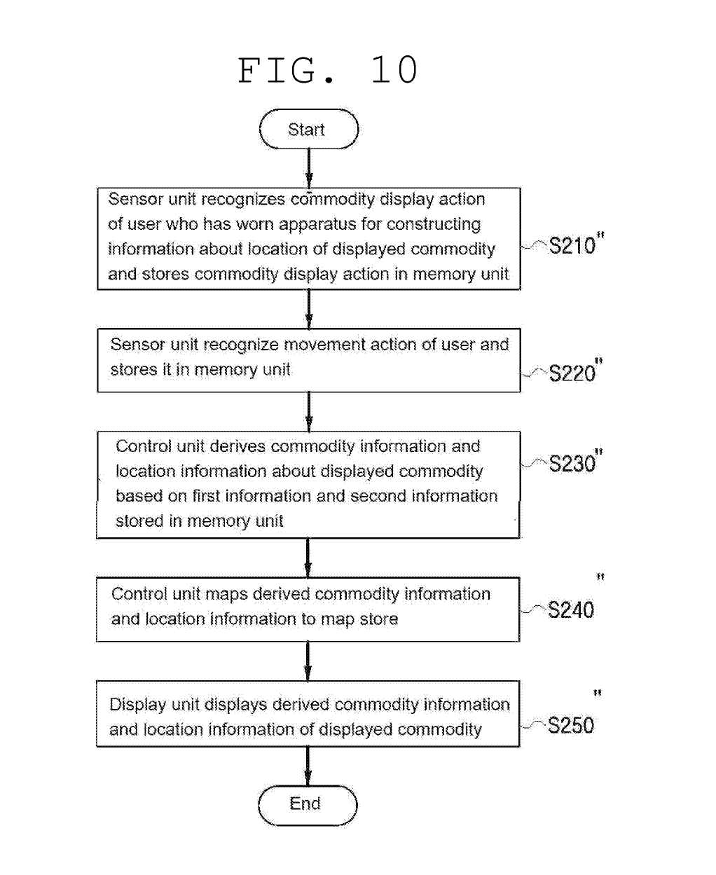

A method for constructing information about the location of a displayed commodity according to a first embodiment of the present invention may be more effectively described through the sensor unit 10′, the memory unit 20′, and the control unit 30′. The method is described below with reference to FIG. 10.

FIG. 10 is a flowchart illustrating a method for constructing information about the location of a displayed commodity according to an embodiment of the present invention.

The method of FIG. 10 is only one embodiment including some exemplary steps according to an embodiment of the present invention, and some of the steps may be modified or omitted or some steps may be added to the method.

First, the sensor unit 10′ recognizes the commodity display action of a user who has worn the apparatus 100′ for constructing information about the location of a displayed commodity and stores the commodity display action in the memory unit 20′ as first information at step S210.″ In this case, the apparatus 100′ for constructing information about the location of a displayed commodity may be a wearable device. More specifically, the apparatus 100′ may be any one of a smart watch, smart glasses, and a smart band. First, an example in which the apparatus 100′ for constructing information about the location of a displayed commodity is smart glasses is described below.

The user may take the commodity display action in the state in which he or she has worn smart glasses that play the role of the apparatus 100′ for constructing information about the location of a displayed commodity. For example, the reason for this is that the user wears the smart glasses so that they accurately face the front and thus an image of a commodity and the display height can be accurately recognized between commodity display actions.

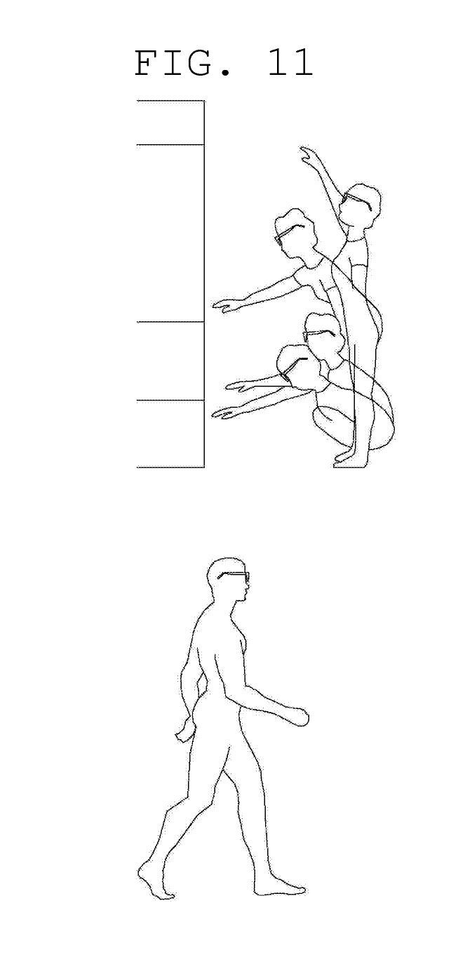

FIG. 11 shows an example in which a user who has worn smart glasses at the front of his or her face takes a commodity display action and a movement action.

The recognition of the commodity display action performed at step S210″ may be stored in the memory unit 20′ of the smart glasses as the first information. The first information may be used to derive commodity information and also location information along with second information according to the recognition of a subsequently stored movement action. Accordingly, the first information according to the recognition of the commodity display action may include an image of a commodity displayed by the user. In this case, an image of the commodity includes an image of the package of the commodity whose information has been exposed and barcode or QR code whose information has been previously stored. The commodity display action may be performed in various ways depending on user characteristics. Accordingly, an image of the package of a commodity may be recognized because a user who has worn smart glasses may not recognize an image of the package of a commodity, barcode or QR code in a process for taking a commodity display action. One or more of commodity images may be recognized.

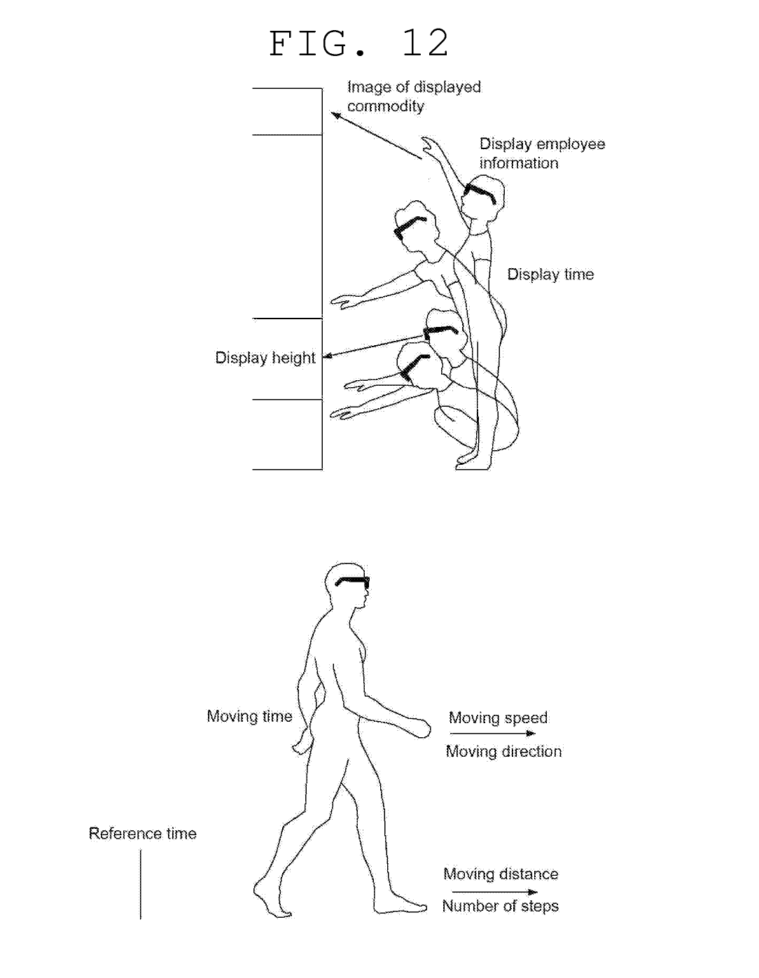

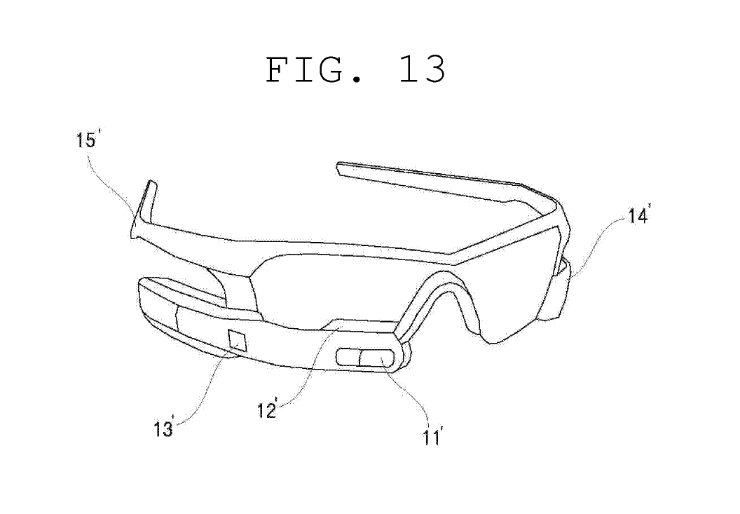

As described above, the sensor unit 10′ recognizes the commodity display action and stores it in the memory unit 20′ as the first information. In this case, the first information may include at least an image of the displayed commodity, and may further include at least one of display employee information, a display time, and a display height. FIG. 12 shows first information stored when a user takes a commodity display action in the state in which he or she has worn smart glasses. Furthermore, the more the commodity display action is accurately recognized, the higher the accuracy of the first information is, the sensor unit 10′ may recognize all of various types of information between commodity display actions. For example, the sensor unit 10′ may recognize various types of information about a user who takes a commodity display action, and may store first information, such as an image of a displayed commodity, display employee information, a display time, and a display height, in the memory unit. In some embodiments, the sensor unit 10′ may include a plurality of sensors having different functions so that each of the plurality of sensors recognizes only specific information. FIG. 13 shows a plurality of sensors mounted on the smart glasses. For example, an image recognition sensor 11′ may recognize an image of the package of a displayed commodity, barcode, QR code, etc. A cornea recognition sensor 12′ may recognize information about a display employee, that is, a user. A first action recognition sensor 13′ may recognize whether a user takes a commodity display action and the direction, time, and height of an action of the user.

The first information is information generated by recognizing the commodity display action. More specifically, the first information includes information regarding that the user has displayed which commodity and that how long has the user taken which display action. For example, the first information may include an image of the commodity and all types of information regarding that the user has taken which action for several seconds, that the user has taken the action in which height, and that the user has taken the action in which range. The first information is used for the control unit 30′ to derive commodity information and location information based on a subsequent commodity display action taken by the user, and may include all types of information about the commodity display action of the user recognized by the sensor unit 10′. Furthermore, the second information may further include information about a user who has taken a commodity display action using a cornea recognition sensor, for example, information about the name, appointment, age, etc. of a commodity display employee, that is, a user.

When the sensor unit 10′ stores the generated first information in the memory unit 20′, the sensor unit 10′ recognizes a movement action of the user and stores it in the memory unit 20′ as second information at step S220.” The first information and the second information are separately stored, but the temporal sequence of the first information and the second information may be changed in storing them and the first information and the second information may be stored at the same time. For example, after taking the movement action, the user may take the commodity display action or after taking the commodity display action at a reference location, the user may take the movement action. In some embodiments, the first information and the second information may be complexly stored in such a manner that a commodity display action is performed, a movement action is performed, and a commodity display action is then performed again.

If the sensor unit 10′ recognizes the movement action of the user and stores it in the memory unit 20′ as the second information, as at step S210″, the user may take the movement action in the state in which he or she has worn smart glasses that plays the role of the apparatus 100′ for constructing information about the location of a displayed commodity. For example, the reason for this is that the user wears the smart glasses so that they accurately face the front and thus a moving distance and a moving direction can be accurately recognized between movement actions.

The movement action performed at step S220″ is stored in the memory unit 20′ of the smart glasses, and forms the second information for deriving a display location along with the first information stored at step S210.″ Accordingly, the second information according to the recognition of the movement action may include the reference location, moving distance, and moving direction of the user. In this case, the reference location is a location, that is, a reference by which the vector values of the moving distance and the moving direction are assigned. The reference location may be recognized at the moment when the user passes through a specific location. In some embodiments, a location where a user takes a commodity display action may become the reference location. Alternatively, the reference location may be directly inputted by a user. The movement action may be performed in various ways depending on user characteristics. Accordingly, the movement action may be recognized and various types of information may be stored in the memory unit 20′ because the moving distance and moving direction of the user may not be accurately recognized due to user characteristics, such as that the user who has worn the smart glasses moves along a route not the shortest distance in a movement action process, that the moving speed of the user is slow, or that the number of steps of the user is many.

As described above, the sensor unit 10′ recognizes the movement action and stores it in the memory unit 20′ as the second information. In this case, the second information may include at least a reference location, a moving distance, and a moving direction, and may further include at least one of a moving speed, a moving time, and the number of steps. FIG. 12 illustrates second information stored when a user who has worn smart glasses takes a movement action. Furthermore, the more the movement action is accurately recognized, the higher the accuracy of the second information is. Accordingly, the sensor unit 10′ may recognize all of various types of information between movement actions. For example, the sensor unit 10′ may recognize various types of information about a user who takes a movement action and store second information, such as the moving speed, moving time, and number of steps of the user, in the memory unit. In some embodiments, the sensor unit 10′ may include a plurality of sensors having different functions so that each of the plurality of sensors recognizes only specific information. FIG. 13 illustrates a plurality of sensors mounted on smart glasses. For example, a second action recognition sensor 14′ may recognize the moving distance, moving direction, moving speed, moving time, etc. of a movement action of a user by sensing a movement of the user. A third action recognition sensor 15′ may recognize the number of steps of a user by sensing a movement of the user.

The second information is information generated by recognizing the movement action. More specifically, the second information includes information regarding that how far has a user moved in which direction and that how fast has the user moved according to which number of steps. The second information is used for the control unit 30′ to subsequently derive information about the location of a displayed commodity in response to a movement action taken by the user. The second information may include all of types of information about the movement action of the user recognized by the sensor unit 10′.

Steps S210″ and S220″ are different in the commodity display action and the movement action and in the first information and the second information, but the temporal sequence of steps S210″ and S220″ may be changed and steps S210″ and S220″ may be performed at the same time. For example, after the movement action of the user is recognized and the first information is stored, the commodity display action may be recognized and the first information may be stored, or after the commodity display action is recognized at a reference location and the first information is stored, the movement action may be recognized and the second information may be stored. However, the first information is information required to derive commodity information about the displayed commodity, and the second information is information required to derive location information about the displayed commodity. Accordingly, in an embodiment of the present invention, the commodity information and location information about the displayed commodity may be constructed only when steps S210″ and S220″ in which the first information and the second information are stored in the memory unit 20′ are performed.

When the first information and the second information are stored in the memory unit 20′, the control unit 30′ derives commodity information and location information about the displayed commodity based on the first information and second information stored in the memory unit 20′ at step S230″. More specifically, the control unit 30′ derives the commodity information and location information about the displayed commodity based on information related to the commodity display action included in the first information and information related to the movement action included in the second information. The first information includes the image of the displayed commodity, and the second information includes the reference location, the moving distance, and the moving direction. Step S230″ includes step S231 for deriving, by the control unit 30′, the commodity information about the displayed commodity based on the image of the displayed commodity included in the first information stored in the memory unit 20′ and step S232 for deriving, by the control unit 30′, the location information about the displayed commodity based on the reference location, the moving distance, and the moving direction included in the second information stored in the memory unit 20′. To derive where which displayed commodity is located simply based on the first information and second information stored in the memory unit 20′ is not accurate. Accordingly, information about a commodity and location derived in response to a commodity display action and a movement action may have been previously stored in the control unit 30′. For example, if a ratio of blue backgrounds is 90%, a ratio of yellow letters is 8%, and a ratio of other white letters is 2% on a surface of packing paper depending on the color ratio, size, and shape of recognized commodity images, commodity information about displayed commodities may be derived based on previously stored information. Furthermore, if an image of a commodity is barcode or QR code, commodity information about the displayed commodity may be derived based on the barcode or QR code. For another example, if the number of steps recognized from a reference point is 100 steps, a moving distance may be derived based on a previously stored stride because the distance may be different depending on the stride of a user. In the case of a simple straight-line movement, location information about a displayed commodity may be immediately derived based on the number of steps that has been previously stored. The first information and the second information recognized in response to a commodity display action and a movement action may have been previously stored when a manufacturer manufactures smart glasses or may be separately stored by a user. Furthermore, information about an image of a displayed commodity recognized in response to a commodity display action may be downloaded from the Internet through a communication unit (not shown) and stored. As described above, commodity information and location information about a displayed commodity may be derived based on information related to the first information and second information stored in the control unit 30′.

In this case, information about a commodity image or the number of steps previously stored in the control unit 30′ is used to derive the commodity information and location information about the displayed commodity. The commodity location may be an area of a column or row in which the commodity has been displayed. Accordingly, the location information about the displayed commodity may be derived based on information about a range previously stored in the memory unit 20′ depending on the range of the area. For example, assuming that the number of steps of a user is 50 steps in a column direction from a reference location and the stride of the user previously stored in the memory unit 20′ is 0.7 m, the control unit 30′ may derive that the user has moved 35 m in the column direction. In this case, if the interval between rows is 4 m and the reference location is the first row, the control unit 30′ may derive that the user has been located near a tenth row, but an accurate location of the tenth row is 36 m. As a result, the control unit 30′ derives that a corresponding commodity is located in the 10 row, that is, the most approximate value of a commodity location calculated through the correction of an error rate. Furthermore, if the user has turned to the right 90 degrees after the 50 steps and then has walked 20 steps in a straight-line direction, the control unit 30′ may derive that the user has moved 14 m along the tenth row. In this case, if the range of a commodity area forming one row is 0.4 m for each commodity, the control unit 30′ derives that the user has been located in a commodity of a 35-th area. Furthermore, if the range of an area of commodities is different for each row and the range of an area forming one row is different, the range of a previously stored commodity area may be stored in the memory unit 20′. If the arrangement of row and columns and the interval between the rows and the columns and the range of each area forming each row are modified, corresponding information may be newly stored in the memory unit 20′.

Furthermore, the control unit 30′ may derive not only the location of a displayed commodity in the form of a two-dimensional location on a plane only, but also location information including the display height of the displayed commodity based on display height information included in first information. For example, when a user takes a commodity display action, the sensor unit 10′ may store height information about a displayed commodity in the memory unit 20′. The control unit 30′ may derive a detailed display height based on a derived two-dimensional location on a plane based on the stored height information. Furthermore, if the interval between the layers of display stands forming respective rows is 0.5 m and a height derived by the sensor unit 10′ is 1.7 m, the control unit 30′ may derive that a displayed commodity has been located in a fourth layer partition through correction.

In other words, when deriving commodity information and location information about a displayed commodity based on first information and second information, the control unit 30′ can derive corrected location information into which information about a store has been incorporated in addition to the two-dimensional location of a commodity on a plane. Furthermore, the control unit 30′ can also derive a three-dimensional location including height information in addition to a two-dimensional location on a plane.

Furthermore, the control unit 30′ may derive commodity information and location information about a displayed commodity using one or more of display employee information, a display time, and a display height included in first information or one or more of a moving speed, a moving time, and the number of steps included in second information. For example, the control unit 30′ may correct an error rate of an image of a commodity included in first information based on display employee information included in the first information stored in the memory unit 20′, may include the corrected error rate in the first information, and may store the first information in the memory unit 20′ again. If a corresponding commodity is not a commodity to be handled, correction may be performed based on information about a display employee, that is, a user. Furthermore, the control unit 30′ may derive location information, including a display height, based on display height information included in the first information and may derive the location information based on information about the number of steps included in the second information, which have been described above and thus a detailed description thereof is omitted.

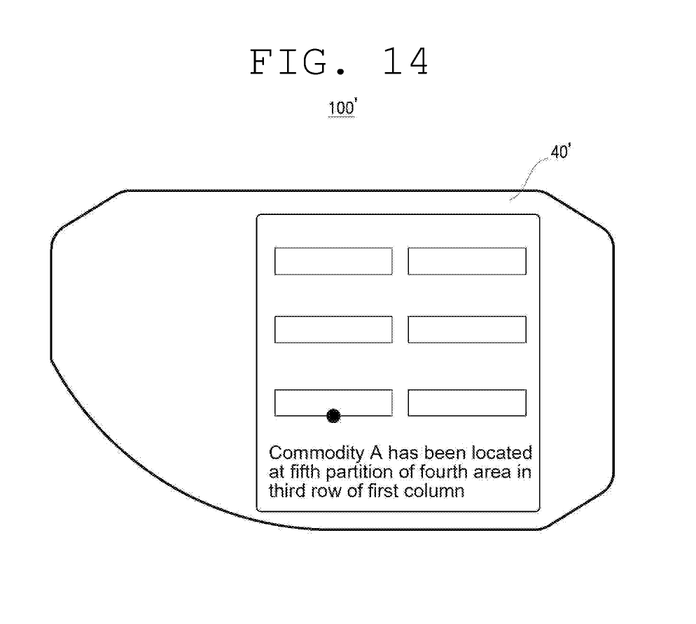

The display unit 40′ may display the derived commodity information and location information about the displayed commodity at step S250″. In this case, the display unit 40′ functions to simply display information, and the control unit 30′ may send the results derived at steps S230″ and S240″. FIG. 14 shows an example in which location information about a displayed commodity is displayed on the display unit 40′ of smart glasses in real time. At this time, commodity information about the displayed commodity and an image of the displayed commodity may also be displayed on the display unit 40′.

The method for constructing information about the location of a displayed commodity according to the first embodiment of the present invention has been described in connection with steps S210″ to S250″. Some of steps S210″ to S250″ may be changed or deleted or some steps may be added to steps S210″ to S250″ as described above. Another embodiment of the present invention is described below.

In the method for constructing information about the location of a displayed commodity according to the first embodiment of the present invention, the first information and the second information are stored in the memory unit 20′ based on the commodity display action and the movement action at steps S210″ and S220″, and the control unit 30′ derives the commodity information and location information about the displayed commodity based on the stored first information and second information. In particular, information according to the commodity image and movement action previously stored in the control unit 30′ has been used at step S240″. In this case, the previously stored information has to be loaded, and the commodity information and location information at step S230″ has to be derived based on the loaded information. Accordingly, there is a possibility that overload may occur when the control unit 30′ processes information because the control unit 30′ has to process too much information at once. A second embodiment for avoiding such a problem may be taken into consideration.

In order to prevent overload concentrated on the control unit 30′, the control unit 30′ may not only derive information about the location of a displayed commodity based on the number of steps, but also may derive location information about the displayed commodity based on a user moving speed and moving time included in second information stored in the memory unit 20′. For example, assuming that the moving speed of a user is an average of 0.7 m/sec in a column direction based on a reference location and a moving time is 30 seconds, the control unit 30′ may derive that the user has moved 21 m in the column direction. In this case, if the interval between rows is 4 m and the reference location is the first row, the control unit 30′ may derive that the user has been located near a sixth row, but an accurate location of the sixth row is 20 m. As a result, the control unit 30′ derives that a corresponding commodity is located in the sixth row, that is, the most approximate value of a commodity location calculated through the correction of an error rate. Furthermore, if the user has turned to the left 90 degrees after 30 seconds and then has walked for 20 seconds in a straight-line direction, the control unit 30′ may derive that the user has moved 14 m along the sixth row. In this case, if the range of a commodity area forming one row is 0.4 m for each commodity, the control unit 30′ derives that the user has been located in a commodity of a 35-th area. That is, according to the second embodiment, a load of information processing can be reduced because when location information is derived, a moving speed and moving time included in second information have only to be derived without information separately previously stored in the memory unit 20′.

In this case, when the control unit 30′ checks that a display time included in the first information is a specific time or more, it may derive the location information about the displayed commodity based on the second information. Since a moving time and moving speed for the same location may be different depending on user characteristics, the control unit 30′ may check that the user does not take a movement action at a specific location for a specific time or more, and may derive corresponding location information based on the second information. Furthermore, the control unit 30′ may correct an error rate of moving time information included in the second information based on a display time included in the first information. The sensor unit 10′ may not clearly separate a commodity display action and a movement action and may not store them in the memory unit 20′ as first information and second information, respectively. Accordingly, the control unit 30′ may adjust an error rate based on the pieces of time information separately stored in the first information and the second information, and may correct overlappingly calculated time information based on the sum of the pieces of time information stored in the first information and the second information.

A third embodiment is related to the mapping of derived location information about the location of a displayed commodity to a store map.

In the third embodiment, after step S230″, the control unit 30′ maps the derived commodity information and location information to a store map at step S240″. The store map may be a two-dimensional map or a three-dimensional map and may include location information having a text form.

Accordingly, the control unit 30′ maps the derived commodity information and location information to a store map including location information about a corresponding store. Accordingly, location information can be more effectively constructed and the management and use of the location information are facilitated. In other words, there are additional advantages in that a user's inconvenience of having to manually input commodity information and location information about a displayed commodity can be obviated and a customer who visits a store can be provided with information about the location of a commodity in real time.

The method for constructing information about the location of a displayed commodity according to each of the first to third embodiments of the present invention may be installed as a function that is basically provided by a wearable device, more specifically, smart glasses, but may be provided in an application form because information about a commodity image, the number of steps, and steps previously stored in the control unit 30′ and information required to map derived information to store map may continue to be downloaded or frequently changed whenever they are required. In this case, if such an application has been registered with an app market regardless of the type of a wearable device, any user can easily download and use the application.

Furthermore, the method for constructing information about the location of a displayed commodity according to each of the first to third embodiments of the present invention may be implemented in a program form, and may be stored in a computer-readable recording medium on which a program for being executed in a computer has been recorded or may be distributed through a program providing server.

The method for constructing information about the location of a displayed commodity according to each of the first to third embodiments of the present invention may be implemented through a smart watch or a smart band in addition to the smart glasses described as a premise. Examples in which the method for constructing information about the location of a displayed commodity is implemented through a smart watch and a smart band other than smart glasses are described based on differences.

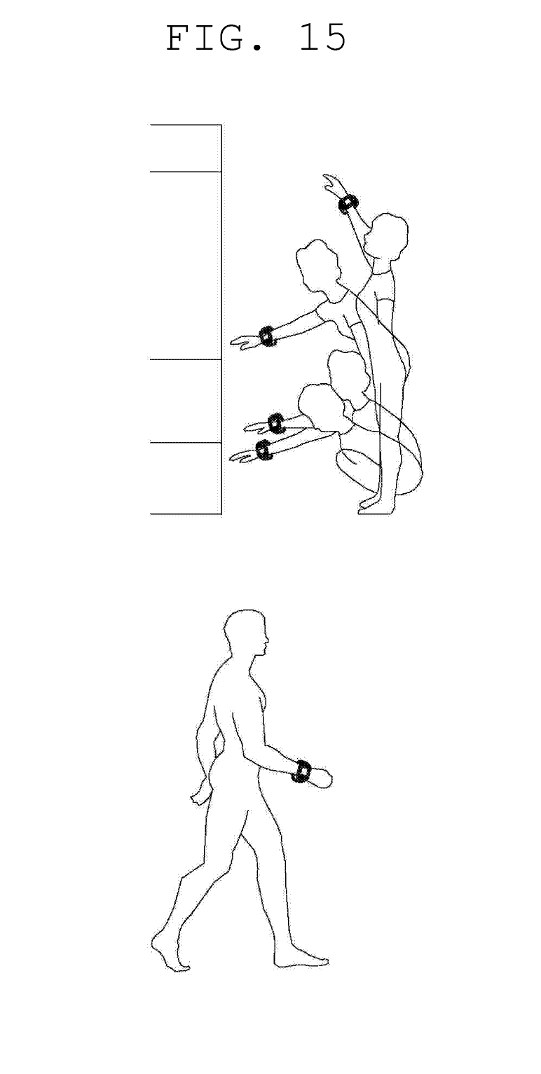

Steps if the method for constructing information about the location of a displayed commodity is implemented through a smart watch may be said to be basically the same as steps S210″ to S250″. It is difficult for a smart watch to recognize an image of a commodity between commodity display actions like smart glasses because the smart watch is worn on the wrist of a user. Accordingly, there is some difference in the sensor unit 10′. As shown in FIG. 15, an image sensor is directed toward the front of the write, and may visually recognize an image of a commodity. In the case of a smart watch, however, other pieces of information, such as display employee information, a display time, and a display height included in first information and a moving speed, a moving time, and the number of steps included in second information, other than a commodity image can be easily recognized between commodity display actions and movement actions compared to smart glasses. Furthermore, smart glasses have an advantage in that they themselves can be used as the display unit 40′ without a separate the display unit 40′. Accordingly, the finally derived commodity information and location information about a commodity, information mapped to a store map, etc. can be projected onto the smart glasses, whereas the smart watch requires a separate display unit 40′.

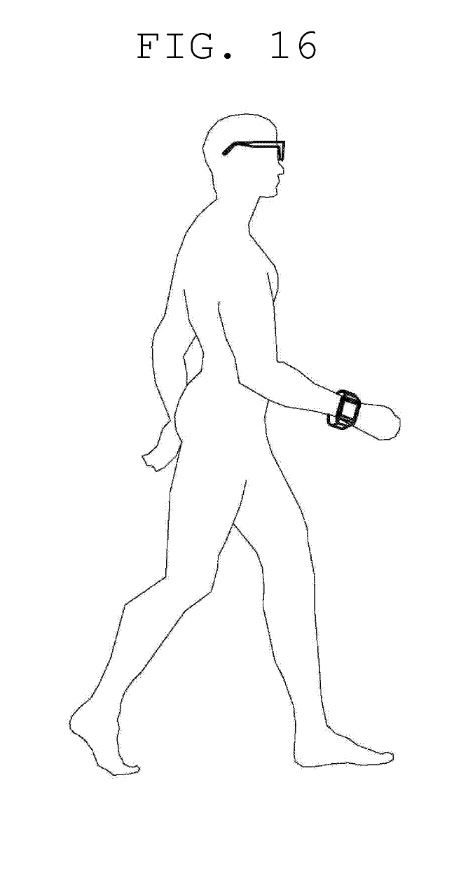

In the case of a smart watch, the size of the display unit 40′ of the smart watch is inevitably limited due to the nature of the watch. In this case, a commodity display action or movement action of a user is recognized through the smart watch, but displayed information may be output through smart glasses. That is, a plurality of wearable devices may operate in conjunction with each other to provide location information about a displayed commodity. More specifically, steps S210″ to S240″ may be performed through a smart watch in the same manner, but only step S250″ may be performed through smart glasses. FIG. 16 shows an example in which a user wears both a smart watch and smart glasses and is provided with location information about a displayed commodity.

In the case of a smart band, there is no problem in recognizing a movement action of a user when the sensor unit 10′ is mounted on the smart band. However, it is difficult for the smart band to recognize an image of a commodity between commodity display actions like smart glasses because the smart band is worn on the wrist of the user like a smart watch. Accordingly, there are some differences in the sensor unit 10′. An image sensor is directed toward the front of the write, and may visually recognize a commodity image. Furthermore, most of smart bands do not include the display unit 40′, and thus the smart band may operate in conjunction with another device to provide location information about a displayed commodity. In this case, another device may be a wearable device, such as a smart watch or smart glasses and may be any device including the display unit 40′ in addition to the wearable device. A user may wear both a smart band and smart glasses and can be provided with the method for constructing information about the location of a displayed commodity.

The first to third embodiments of the method for constructing information about the location of a displayed commodity and implementation examples through smart glasses, a smart watch, and a smart band have been described so far. Such a method for constructing information about the location of a displayed commodity may be implemented using the apparatus 100′ for constructing information about the location of a displayed commodity, which has a different category, but includes substantially the same technical characteristics as the method for constructing information about the location of a displayed commodity. This has been described in brief with reference to FIG. 9, and thus a detailed description thereof is omitted.

As described with reference to FIG. 9, the apparatus 100′ for constructing information about the location of a displayed commodity includes the sensor unit 10′, the memory unit 20′, and the control unit 30′, and may include other elements according to an embodiment of the present invention. Meanwhile, the apparatus 100′ for constructing information about the location of a displayed commodity may be any one of a smart watch, smart glasses, and a smart band. First, an example in which the apparatus 100′ is smart glasses is described below.

The sensor unit 10′ recognizes the commodity display action of a user who has worn the apparatus 100′ for constructing information about the location of a displayed commodity and stores the commodity display action in the memory unit 20′ as first information. The user may take a commodity display action in the state in which he or she has worn smart glasses that play the role of the apparatus 100′ for constructing information about the location of a displayed commodity. For example, the reason for this is that the user wears the smart glasses so that they accurately face the front and thus an image of a commodity and the display height can be accurately recognized between commodity display actions.

The recognition of the commodity display action performed by the sensor unit 10′ may be stored in the memory unit 20′ of the smart glasses as the first information. The first information may be used to derive commodity information and also location information along with second information according to the recognition of a subsequently stored movement action. Accordingly, the first information according to the recognition of the commodity display action may include an image of a commodity displayed by the user. In this case, an image of the commodity includes an image of the package of the commodity whose information has been exposed and barcode or QR code whose information has been previously stored. The commodity display action may be performed in various ways depending on user characteristics. Accordingly, an image of the package of a commodity may be recognized because a user who has worn smart glasses may not recognize an image of the package of a commodity, barcode or QR code in a process for taking a commodity display action. One or more of commodity images may be recognized.

As described above, the sensor unit 10′ recognizes the commodity display action and stores it in the memory unit 20′ as the first information. In this case, the first information may include at least an image of the displayed commodity, and may further include at least one of display employee information, a display time, and a display height. The first information is stored when the user takes the commodity display action in the state in which he or she has worn smart glasses (see FIG. 12). Furthermore, the more the commodity display action is accurately recognized, the higher the accuracy of the first information is, the sensor unit 10′ may recognize all of various types of information between commodity display actions. For example, the sensor unit 10′ may recognize various types of information about a user who takes a commodity display action, and may store first information, such as an image of a displayed commodity, display employee information, a display time, and a display height, in the memory unit. In some embodiments, the sensor unit 10′ may include a plurality of sensors having different functions so that each of the plurality of sensors recognizes only specific information. The smart glasses may have a plurality of sensors mounted thereon (see FIG. 13). For example, an image recognition sensor 11′ may recognize an image of the package of a displayed commodity, barcode, QR code, etc. A cornea recognition sensor 12′ may recognize information about a display employee, that is, a user. A first action recognition sensor 13′ may recognize whether a user takes a commodity display action and the direction, time, and height of an action of the user.

The first information is information generated by recognizing the commodity display action. More specifically, the first information includes information regarding that the user has displayed which commodity and that how long has the user taken which display action. For example, the first information may include an image of the commodity and all types of information regarding that the user has taken which action for several seconds, that the user has taken the action in which height, and that the user has taken the action in which range. The first information is used for the control unit 30′ to derive commodity information and location information based on a subsequent commodity display action taken by the user, and may include all types of information about the commodity display action of the user recognized by the sensor unit 10′. Furthermore, the second information may further include information about a user who has taken a commodity display action using a cornea recognition sensor, for example, information about the name, appointment, age, etc. of a commodity display employee, that is, a user.

In other words, the sensor unit 10′ recognizes the commodity display action and movement action taken by the user and stores them in the memory unit 20′ as the first information and the second information. The stored first information and second information are used for the control unit 30′ to construct the location information about the displayed commodity. Reference may be made to FIGS. 11 to 15 for a detailed visual description of the sensor unit 10′. The memory unit 20′ functions as a space for storing information and has been described in detail above. The control unit 30′ is described below.

The control unit 30′ derives commodity information and location information about the displayed commodity based on the first information and second information stored in the memory unit 20′. More specifically, the control unit 30′ derives the commodity information and location information about the displayed commodity based on information related to the commodity display action included in the first information and information related to the movement action included in the second information. The first information includes an image of the displayed commodity, and the second information includes a reference location, a moving distance, and a moving direction. To derive where which displayed commodity is located simply based on the first information and second information stored in the memory unit 20′ is not accurate. Accordingly, information about a commodity and location derived in response to a commodity display action and a movement action may have been previously stored in the control unit 30′. For example, if a ratio of blue backgrounds is 90%, a ratio of yellow letters is 8%, and a ratio of other white letters is 2% on a surface of packing paper depending on the color ratio, size, and shape of recognized commodity images, commodity information about displayed commodities may be derived based on previously stored information. Furthermore, if an image of a commodity is barcode or QR code, commodity information about the displayed commodity may be derived based on the barcode or QR code. For another example, if the number of steps recognized from a reference point is 100 steps, a moving distance may be derived based on a previously stored stride because the distance may be different depending on the stride of a user. In the case of a simple straight-line movement, location information about a displayed commodity may be immediately derived based on the number of steps that has been previously stored. The first information and the second information recognized in response to a commodity display action and a movement action may have been previously stored when a manufacturer manufactures smart glasses or may be separately stored by a user. Furthermore, information about an image of a displayed commodity recognized in response to a commodity display action may be downloaded from the Internet through a communication unit (not shown) and stored. As described above, commodity information and location information about a displayed commodity may be derived based on information related to the first information and second information stored in the control unit 30′.

In this case, information about a commodity image or the number of steps previously stored in the control unit 30′ is used to derive the commodity information and location information about the displayed commodity. The commodity location may be an area of a column or row in which the commodity has been displayed. Accordingly, the location information about the displayed commodity may be derived based on information about a range previously stored in the memory unit 20′ depending on the range of the area. For example, assuming that the number of steps of a user is 50 steps in a column direction from a reference location and the stride of the user previously stored in the memory unit 20′ is 0.7 m, the control unit 30′ may derive that the user has moved 35 m in the column direction. In this case, if the interval between rows is 4 m and the reference location is the first row, the control unit 30′ may derive that the user has been located near a tenth row, but an accurate location of the tenth row is 36 m. As a result, the control unit 30′ derives that a corresponding commodity is located in the 10 row, that is, the most approximate value of a commodity location calculated through the correction of an error rate. Furthermore, if the user has turned to the right 90 degrees after the 50 steps and then has walked 20 steps in a straight-line direction, the control unit 30′ may derive that the user has moved 14 m along the tenth row. In this case, if the range of a commodity area forming one row is 0.4 m for each commodity, the control unit 30′ derives that the user has been located in a commodity of a 35-th area. Furthermore, if the range of an area of commodities is different for each row and the range of an area forming one row is different, the range of a previously stored commodity area may be stored in the memory unit 20′. If the arrangement of row and columns and the interval between the rows and the columns and the range of each area forming each row are modified, corresponding information may be newly stored in the memory unit 20′.

Furthermore, the control unit 30′ may derive not only the location of a displayed commodity in the form of a two-dimensional location on a plane only, but also location information including the display height of the displayed commodity based on display height information included in first information. For example, when a user takes a commodity display action, the sensor unit 10′ may store height information about a displayed commodity in the memory unit 20′. The control unit 30′ may derive a detailed display height based on a derived two-dimensional location on a plane based on the stored height information. Furthermore, if the interval between the layers of display stands forming respective rows is 0.5 m and a height derived by the sensor unit 10′ is 1.7 m, the control unit 30′ may derive that a displayed commodity has been located in a fourth layer partition through correction.

In other words, when deriving commodity information and location information about a displayed commodity based on first information and second information, the control unit 30′ can derive corrected location information into which information about a store has been incorporated in addition to the two-dimensional location of a commodity on a plane. Furthermore, the control unit 30′ can also derive a three-dimensional location including height information in addition to a two-dimensional location on a plane.

Furthermore, the control unit 30′ may derive commodity information and location information about a displayed commodity using one or more of display employee information, a display time, and a display height included in first information or one or more of a moving speed, a moving time, and the number of steps included in second information. For example, the control unit 30′ may correct an error rate of an image of a commodity included in first information based on display employee information included in the first information stored in the memory unit 20′, may include the corrected error rate in the first information, and may store the first information in the memory unit 20′ again. If a corresponding commodity is not a commodity to be handled, correction may be performed based on information about a display employee, that is, a user.

Furthermore, in order to prevent overload concentrated on the control unit 30′, the control unit 30′ may not only derive information about the location of a displayed commodity based on the number of steps, but also may derive location information about the displayed commodity based on a user moving speed and moving time included in second information stored in the memory unit 20′. For example, assuming that the moving speed of a user is an average of 0.7 m/sec in a column direction based on a reference location and a moving time is 30 seconds, the control unit 30′ may derive that the user has moved 21 m in the column direction. In this case, if the interval between rows is 4 m and the reference location is the first row, the control unit 30′ may derive that the user has been located near a sixth row, but an accurate location of the sixth row is 20 m. As a result, the control unit 30′ derives that a corresponding commodity is located in the sixth row, that is, the most approximate value of a commodity location calculated through the correction of an error rate. Furthermore, if the user has turned to the left 90 degrees after 30 seconds and then has walked for 20 seconds in a straight-line direction, the control unit 30′ may derive that the user has moved 14 m along the sixth row. In this case, if the range of a commodity area forming one row is 0.4 m for each commodity, the control unit 30′ derives that the user has been located in a commodity of a 35-th area. That is, according to the second embodiment, a load of information processing can be reduced because when location information is derived, a moving speed and moving time included in second information have only to be derived without information separately previously stored in the memory unit 20′.

In this case, when the control unit 30′ checks that a display time included in the first information is a specific time or more, it may derive the location information about the displayed commodity based on the second information. Since a moving time and moving speed for the same location may be different depending on user characteristics, the control unit 30′ may check that the user does not take a movement action at a specific location for a specific time or more, and may derive corresponding location information based on the second information. Furthermore, the control unit 30′ may correct an error rate of moving time information included in the second information based on a display time included in the first information. The sensor unit 10′ may not clearly separate a commodity display action and a movement action and may not store them in the memory unit 20′ as first information and second information, respectively. Accordingly, the control unit 30′ may adjust an error rate based on the pieces of time information separately stored in the first information and the second information, and may correct overlappingly calculated time information based on the sum of the pieces of time information stored in the first information and the second information.

Furthermore, the control unit 30′ may map the derived commodity information and location information to a store map. The store map may be a two-dimensional map or a three-dimensional map and may include location information having a text form. Accordingly, the control unit 30′ maps the derived commodity information and location information to a store map including location information about a corresponding store. Accordingly, location information can be more effectively constructed and the management and use of the location information are facilitated. In other words, there are additional advantages in that a user's inconvenience of having to manually input commodity information and location information about a displayed commodity can be obviated and a customer who visits a store can be provided with information about the location of a commodity in real time.

The apparatus 100′ for construction information about the location of a displayed commodity has been described so far based on smart glasses, and there are some differences in implementations using a smart watch or a smart band. This is described below.

If the apparatus 100′ for construction information about the location of a displayed commodity is implemented through a smart watch, the sensor unit 10′, the memory unit 20′, and the control unit 30′ may be considered to be basically the same. However, it is difficult for the smart watch to recognize an image of a commodity between commodity display actions like smart glasses because the smart watch is worn on the wrist of a user. Accordingly, there is some difference in the sensor unit 10′. An image sensor is directed toward the front of the write, and may visually recognize an image of a commodity. In the case of a smart watch, however, other pieces of information, such as display employee information, a display time, and a display height included in first information and a moving speed, a moving time, and the number of steps included in second information, other than a commodity image can be easily recognized between commodity display actions and movement actions compared to smart glasses. Furthermore, smart glasses have an advantage in that they themselves can be used as the display unit 40′ without a separate the display unit 40′. Accordingly, the finally derived commodity information and location information about a commodity, information mapped to a store map, etc. can be projected onto the smart glasses, whereas the smart watch requires a separate display unit 40′.

In the case of a smart watch, the size of the display unit 40′ of the smart watch is inevitably limited due to the nature of the watch. In this case, a commodity display action or movement action of a user is recognized through the smart watch, but displayed information may be output through smart glasses. That is, a plurality of wearable devices may operate in conjunction with each other to provide location information about a displayed commodity. More specifically, the sensor unit 10′, the memory unit 20′, and the control unit 30′ are basically the same, but only the display unit 40′ may be performed through smart glasses. A user who has worn both the smart watch and the smart glasses can be provided with location information about a displayed commodity (see FIG. 16).

In the case of a smart band, there is no problem in recognizing a movement action of a user when the sensor unit 10′ is mounted on the smart band. However, it is difficult for the smart band to recognize an image of a commodity between commodity display actions like smart glasses because the smart band is worn on the wrist of the user like a smart watch. Accordingly, there are some differences in the sensor unit 10′. An image sensor is directed toward the front of the write, and may visually recognize a commodity image. Furthermore, most of smart bands do not include the display unit 40′, and thus the smart band may operate in conjunction with another device to provide location information about a displayed commodity. In this case, another device may be a wearable device, such as a smart watch or smart glasses and may be any device including the display unit 40′ in addition to the wearable device. A user may wear the apparatus 100′ for construction information about the location of a displayed commodity, which is composed of a smart band and smart glasses.

As described above, those skilled in the art to which the present invention pertains will appreciate that the present invention may be implemented in other detailed forms without changing the technical spirit or essential characteristic of the present invention. Accordingly, it is to be understood that the aforementioned embodiments are only illustrative and do not have a limited range. Furthermore, the illustrated flowcharts are merely order illustrated in implementing the present invention, and other additional steps may be provided or some of steps may be deleted

Technological characteristics described in this specification and an implementation for executing the technological characteristics may be implemented using a digital electronic circuit, may be implemented using computer software, firmware or hardware including the structure described in this specification and structural equivalents thereof, or may be implemented using a combination of one or more of them.

Furthermore, the implementation for executing the technological characteristics described in this specification may be implemented using a computer program product, that is, a module regarding computer program instructions encoded on a kind of program storage media in order to control the operation of a processing system or for execution by the processing system.

A computer-readable medium may be a machine-readable storage device, a machine-readable storage substrate, a memory device, a composition of materials that affect a machine-readable electromagnetic signal or a combination of one or more of them.

In this specification, the terms “apparatus or device” or “system” cover all apparatuses, devices, and machines for processing data, for example, including a processor, a computer or a multi-processor, or a computer. The processing system may include, for example, code that forms processor firmware, a protocol stack, a database management system, an operating system, or all types of code that form an execution environment for a computer program when a combination of one or more of them is requested, in addition to hardware.

A computer program also known as a program, software, a software application, a script or code may be written in any form of a programming language which includes a compiled or interpreted language or a transcendental and/or procedural language, and may also be implemented in any form including an independent program or module, a component, a subroutine or other units suitable for being used in a computer environment.

The computer program does not need to necessarily correspond to a file of a file system. The program may be stored in a single file provided to a requested program, multiple files that interact with each other (e.g., a file that stores one or more modules, a lower program or part of code), or another program or part of a file including data (e.g., one or more scripts stored in markup language document).

The computer program may be located in a single site or distributed to a plurality of sites and may be implemented to be executed on multiple computers or one or more computers interconnected over wired/wireless communication networks.

A computer-readable medium suitable for storing computer program instructions and data may include semiconductor memory devices, such as EPROM, EEPROM, and a flash memory device, for example, all types of non-volatile memory, media, and memory devices including magnetic disks, such as an internal hard disk or an external disk, magneto optical disks, CDs, and DVDs. The processor and the memory may be supplemented by a logic circuit for a special object or may be integrated into the logic circuit for a special object.

An implementation for executing the subject matter described in this specification may be implemented in an operation system including a backend component, such as a data server, a middleware component, such as an application server, a frontend component, such as a client computer having a web browser or graphic user interface capable of interacting with the implementation of the subject matter described by a user in this specification or all combinations of one or more of the backend, middleware, and frontend components. The component of the system may be accessed by any type or medium for digital data communication, such as a communication network.

Hereinafter, more detailed embodiments capable of implementing the above-described contents and the system and the method for providing a service using the system for automatically calculating a parking fee, described in this specification described in this specification are described in detail.

The system and the method for providing a service using the system for automatically calculating a parking fee, which have been described in this specification, may be used partially or generally through a server related to a client device or web-based storage system or means for executing computer software, program code or instructions on one or more processors included in a server.

In this case, the processor may be part of a server, a client, network infrastructure, or a computing platform, such as a mobile computing platform or fixed computing platform. More specifically, the processor may be a kind of computer or processing device capable of executing program instructions, code, etc. Furthermore, the processor may further include memory for storing the method, instructions, code or program for providing a service using the system for automatically calculating a parking fee. If memory is not included in the processor, the processor may access a storage device, such as CD-ROM, DVD, memory, a hard disk, a flash drive, RAM, ROM, or a cache in which the method, instructions, code or program for providing a service using the system for automatically calculating a parking fee.

Furthermore, the system and the method for providing a service using the system for automatically calculating a parking fee, which have been described in this specification, may be used partially or generally through an apparatus for executing computer software on a server, a client, a gateway, a hub, a router or network hardware.

In this case, the software may be executed in various types of servers, such as a file server, a print server, a domain server, an Internet server, an intranet server, a host server, and a distributed server. The aforementioned servers may further include memory, a processor, a computer-readable storage medium, a storage medium, a communication device, a port, a client, and an interface capable of accessing other servers over wired/wireless networks.

Furthermore, the method, instructions, or for providing a service using the system for automatically calculating a parking fee may also be executed by a server. Other devices required to execute the method for providing a service using the system for automatically calculating a parking fee may be implemented as part of a hierarchical structure associated with the server.

Furthermore, the server may provide an interface to other devices including a client, another server, a printer, a database server, a print server, a file server, communication a server, and a distributed server without limitation. A connection through the interface may enable a program to be easily executed at a remote place over wired/wireless networks.

Furthermore, any one of devices connected to the server through the interface may further include at least one storage device capable of storing the method, instructions or code for providing a service using the system for automatically calculating a parking fee. The central processor of the server may provide instructions, code, etc. to be executed on another device to the device so that the instructions, code, etc. are stored in a storage device.

The system and the method for providing a service using the system for automatically calculating a parking fee, which have been described in this specification, may be used partially or generally through network infrastructure.

In this case, the network infrastructure may include all of devices, such as a computing device, a server, a router, a hub, a firewall, a client, a personal computer, a communication device, and a routing device, and separate modules capable of executing respective functions. The network infrastructure may further include storage media, such as story flash memory, a buffer, a stack, RAM, and ROM, in addition to the aforementioned devices and module.

Furthermore, the method, instructions or code for providing a service using the system for automatically calculating a parking fee may also be executed by and stored in any one of the device, module, and storage medium included in the network infrastructure. Another device required to execute the method for providing a service using the system for automatically calculating a parking fee may also be implemented as part of the network infrastructure.

Furthermore, the wearable device and method for providing a service using the system for automatically calculating a parking fee, which have been described in this specification, may be implemented using hardware or hardware suitable for a specific application and software. In this case, the hardware includes all of general-purpose computer devices, such as a personal computer and a mobile communication terminal, and a business type specific computer device. The computer device may be implemented using a device, such as memory, a microprocessor, a microcontroller, a digital signal processor, an application-specific integrated circuit, a programmable gate array, programmable array logic or a combination of them.

The aforementioned computer software, instructions, code, etc. may be stored or accessed by a readable device. In this case, the readable device may include memory, such as a computer component including digital data used for computing for a specific time, semiconductor storage, such as RAM or ROM, permanent storage, such as an optical disk, high-capacity storage, such as a hard disk, a tape and a drum, optical storage, such as a CD or DVD, and network access type storage, such as flash memory, a floppy disk, a magnetic tape, a paper tape, an independent type RAM disk, high-capacity storage detachable from a computer, dynamic memory, static memory, variable storage, and cloud.

In this case, the instructions, code, etc. include all of languages, such as data-oriented languages, such as SQL and dBase, system languages, such as C, Objective C, C++, and Assembly, architecture languages, such as Java and NET, and application languages, such as PHP, Ruby, Perl, and Python, but are not limited thereto. The instructions, code, etc. may include all of languages widely known to those skilled in the art to which the present invention pertains.

Furthermore, the “computer-readable medium” described in this specification includes all of media which contribute to the provision of instruction to a processor in order to execute a program. More specifically, the “computer-readable medium” includes non-volatile media, such as a data storage device, an optical disk and a magnetic disk, volatile media, such as dynamic memory, and transmission media, such as a coaxial cable, a copper wire and an optical fiber for sending data, but is not limited thereto.

The elements for executing the technical characteristics of the present invention included in the block diagrams and flowcharts shown in the accompanying drawings of this specification mean the logical boundary between the elements.

In accordance with a software or hardware embodiment, however, the functions of the illustrated elements and functions thereof may be implemented so that the elements and functions thereof are executed in the form of an independent software module, a monolithic software structure, code, a service or a combination of them and are stored in a medium which is executable by a computer including a processor capable of executing stored program code and instructions. Accordingly, all of such embodiments should be construed as belonging to the scope of the present invention.

Accordingly, the accompanying drawings and technologies thereof describe the technical characteristics of the present invention, but should not be simply reasoned unless a specific array of software for implementing such technical characteristics is clearly described otherwise.

That is, the aforementioned various embodiments may be present and may be partially modified while having the same technical characteristics as those of the present invention. Accordingly, such modified embodiments should be construed as belonging to the scope of the present invention.

Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous.

Furthermore, the separation of various system components in the aforementioned embodiments should not be construed as requesting such separation in all the embodiments. It should be understood that the aforementioned program components and systems may be integrated into a single software product or packaged into a multi-software product.

In accordance with an embodiment of the present invention, a user can conveniently use a parking facility without inconvenience experienced when he or she exits from the parking facility because a parking fee is automatically deduced using payment information (e.g., SMS, an electronic receipt) generated when he or she performs consumption activities in a method for paying a charge for using the parking facility for consumption activities at a department store, for example.

Furthermore, there is an advantage in that a cost for a service for automatically calculating a parking fee can be reduced without an additional system design cost because the service for automatically calculating a parking fee can be provided by modifying the existing system of a card company or through a system for calculating a parking fee without affiliation with a card company.

Furthermore, user convenience can be improved because a user can present various types of digital content or the various types of digital content are automatically incorporated when a parking fee is calculated so that the user can have a discount and/or a reduction of a fee in addition to the calculation of the parking fee according to consumption activities within a store.

In accordance with an embodiment of the present invention, there is an advantage in that a user can conveniently construct information about the location of displayed commodities within a store because a commodity display action and movement action of the user are recognized and information about the location of the displayed commodities is provided.

Furthermore, a user's inconvenience of having to manually input commodity information and location information about a displayed commodity can be obviated because information about the location of displayed commodities is constructed and derived commodity information and location information are mapped to a store map.

Furthermore, there is an additional advantage in that a customer who uses a store can be provided with information about the location of a commodity in real time.

Advantages of the present invention are not limited to the aforementioned advantages and may include various other advantages within a range evident to those skilled in the art from the above description.

As described above, this specification is not intended to limit the embodiments of the present invention by the proposed detailed terms. Accordingly, although the present invention has been described in detail in connection with the aforementioned embodiments, a person having ordinary skill in the art to which the present invention pertains may alter, change, and modify the embodiments without departing from the scope of the present invention.

The scope of the present invention is defined by the appended claims rather than the detailed description, and the present invention should be construed as covering all modifications or variations derived from the meaning and scope of the appended claims and their equivalents.

What is claimed is:

1. A method for constructing information about a location of a displayed commodity, the method comprising:
(a) recognizing, by a sensor unit, a commodity display action of a user who has worn an apparatus for constructing location information and storing the commodity display action in a memory unit as first information;
(b) recognizing, by the sensor unit, a movement action of the user and storing the movement action in the memory unit as second information; and
(c) deriving, by a control unit, commodity information and location information about a displayed commodity based on the first information and second information stored in the memory unit.

2. The method of claim 1, wherein:
the first information comprises at least an image of the displayed commodity, and
the second information comprises at least a reference location, a moving distance, and a moving direction.

3. The method of claim 2, wherein the step (c) comprises steps of:
(c-1) deriving, by the control unit, the commodity information about the displayed commodity based on the image of the displayed commodity of the first information stored in the memory unit; and
(c-2) deriving, by the control unit, the location information about the displayed commodity based on the reference location, the moving distance, and the moving direction of the second information stored in the memory unit.

4. The method of claim 3, wherein:
the first information further comprises at least one of display employee information, a display time, and a display height, and
the second information further comprises at least one of a moving speed, a moving time, and a number of steps.

5. The method of claim 4, wherein:
the first information comprises the display time, and
at the step (c-2), if the display time included in the first information is a specific time or more, the control unit derives the location information about the displayed commodity based on the second information or corrects an error rate of the moving time of the second information based on the display time of the first information and derives the location information based on the moving speed of the second information.

6. The method of claim 4, wherein:
the first information comprises the display height, and
at the step (c-2), the control unit derives the location information comprising the display height based on the display height of the first information.

7. The method of claim 4, wherein:
the second information comprises the number of steps, and
at step (c-2), the control unit derives the location information based on the number of steps of the second information.

8. An apparatus for constructing information about a location of a displayed commodity, comprising:
a sensor unit configured to generate first information and second information by recognizing a commodity display action and movement action of a user;
a memory unit configured to store the first information and second information generated by the sensor unit; and
a control unit configured to derive commodity information and location information about a displayed commodity based on the first information and second information stored in the memory unit.
